(19) United States
(12) Patent Application Publication
(10) Pub. No.: US 2010/0298863 A1
(43) Pub. Date: Nov. 25, 2010

(54) METHOD, SYSTEM AND DEVICE FOR ELECTRONIC ACUPUNCTURE AND PRESSURE, MOISTURE AND VOLTAGE CONTROL THEREFOR

(76) Inventors: John R. Hindinger, Dearborn, MI (US); Ramon Nunez, Waterford, MI (US)

Correspondence Address: CHARTER IP, LLC, P.O. BOX 64, The Plains, VA, 20198, US

(21) Appl. No.: 12/755,385

(22) Filed: Apr. 6, 2010

Related U.S. Application Data
(63) Continuation-in-part of application No. 11/377,881, filed on Mar. 17, 2006, now Pat. No. 7,693,579.

(51) Int. Cl. A61H 39/04; A61H 39/02

(52) U.S. Cl. 606/204; 600/548

(57) ABSTRACT

A method, system and device for electronic acupuncture and controls therefor, in which the device includes a main electronics unit having a display thereon and intelligence therein for providing one of diagnosis and/or treatment of a patient. A pressure sensitive search probe is operatively connected to the main unit. The search probe has a self-moistening probe tip adapted to apply pressure against the skin of a patient and to receive a current from the patient. The probe tip is subject to moisture control so that the probe tip has consistent moisture and the search probe is subject to pressure control so that the probe tip is applied with a constant pressure to a patient's skin. A grip probe is operatively connected via an electrical connector to the main unit. A patient grasps the grip probe and the search probe is applied to the patient's skin to complete an electrical circuit.

### PRIORITY STATEMENT

This application is a continuation-in-part of and claims the benefit under 35 U.S.C. §120 of U.S. patent application Ser. No. 11/377,881, now U.S. Pat. No. 7,693,579, filed Mar. 17, 2006 to Hindinger et al. and entitled “ELECTRONIC ACUPUNCTURE DEVICE AND SYSTEM, AND METHOD OF MANAGING MERIDIAN ENERGY BALANCE DATA OF A PATIENT”, the entire contents of which is hereby incorporated by reference herein.

### BACKGROUND

1. Field

The example embodiments relate in general to an electronic acupuncture device and system having one or more of pressure control for a search probe, moisture control for a tip of the search probe that contacts a patient's skin, and voltage control of a voltage applied to the patient, so as to provide noninvasive acupuncture diagnosis and treatment for the patient.

2. Related Art

Although few in the western hemisphere understand acupuncture, western medicine is waking up to its benefits. In general, acupuncture may be described as managing the body's life energy, or Chi, by redirecting the body's energy through a series of points on the body that form lines called meridians. Meridians map loosely to internal organs, providing another perspective from which to view acupuncture's benefits. Although theories disagree as to how the body transfers Chi across meridians, empirical evidence to its efficacy is overwhelming.

By studying thousands of years of predominantly Chinese medicine, acupuncturists know the locations of acupuncture points and how to insert needles into these points, known as energy meridian points, in order to govern Chi flow. Western medicine has verified the existence of many energy meridian points by measuring the high electrical conductivity at these points.

In the early 1950's, a Japanese doctor applied the conductivity principle in inventing the Ryodoraku protocol, a quick and simplified methodology of reaping many of acupuncture's benefits with electricity. Dr. Yoshio Nakatani noted areas of altered electrical conductivity on the skin of patients with various diseases. These areas were found to be points of approximately 1 cm diameter, generally in lines following the classical Chinese acupuncture meridians. Because these points offered increased electrical conductance, he named these points “ryodoraku” (ryo=good, do=(electro) conductive, raku=line.)

Dr. Nakatani refined his procedures to encompass both diagnosis and treatment. Diagnosis was performed with an electrical instrument measuring electrical conductivity of the skin. By measuring the conductivity of each energy meridian, energetic excesses and deficiencies could be located. Treatment consisted of stimulating specific acupuncture points to either “tonify” a deficient meridian, or “sedate” an excessive meridian. An additional set of acupuncture points was used to balance meridians that showed significant energetic differences between the right and left sides of the body. Thus, in general, a simple form of the Ryodoraku technique treats multiple conditions by balancing the body's Chi across its twelve (12) major or main energy meridians: heart, pericardium, lung, triple heater (San Jiao), large intestine, small intestine, kidney, bladder, gall bladder, spleen, stomach and liver.

Prior art electronic acupuncture units are typically bulky, involve little or no automation, and exhibit no voltage control. The prior art electronic acupuncture devices are little more than a power source having either a voltage that tapers to zero, which sacrifices diagnosis accuracy, or a voltage below those recommended by Ryodoraku, and a memory which typically stores inaccurate conductivity readings. Users typically must plot the diagnosis by hand prior to rendering any kind of treatment.

A prior art acupuncture device by Miridia Technologies known as the AcuGraph® incorporates a software package that runs on a user's personal computer (PC), and uses electronic hardware powered by and attached to the PC. However, the electronic hardware attached to the AcuGraph® is incapable of providing accurate Ryodoraku diagnosis voltages because it draws power at approximately five (5) volts from a computer's Universal Serial Bus (USB) port, but incorporates no circuitry to boost the voltage to the twelve (12) volts called for in the Ryodoraku diagnosis. Although the AcuGraph® uses an algorithm to normalize its readings as if they were taken at the correct voltage, the AcuGraph® is incapable of administering proper diagnosis voltage to the user, introducing the potential for deviation from the Ryodoraku protocol. In addition, the AcuGraph® is not designed for and cannot produce the higher voltages required for administering needle-free treatment, and thus serves only as a diagnostic tool.

Further, diagnosing the acupuncture meridians is typically difficult for many practitioners. This is because the traditional methods for doing so, such as pulse diagnosis, are complex and typically require decades to master.

### SUMMARY

An example embodiment of the present invention is directed to a method of managing meridian energy data of a patient to treat the patient. The method includes applying a diagnosis voltage generated by a processor in a hand held electronic device to the patient at each of the patient's major energy meridian points, the electronic device powered by a power source having disposable or rechargeable battery cells and configured to generate a given output voltage under control of the processor that generates a given current in the patient, measuring data by the electronic device that corresponds to the patient's major energy meridian points based on the applied diagnosis voltage, communicating the measured data to a remote computing device for diagnosis or treatment of the patient, analyzing the measured energy meridian point data of the patient at the remote computing device, the rechargeable cells of the power source rechargeable by way of a recharging stand or cradle of a battery charger configured to upload data stored in the electronic device via the recharging stand or cradle to the remote computing device, and determining a relative energy balance across the patient's major energy meridian points based on the analysis.

Another example embodiment is directed to an electronic acupuncture system for providing noninvasive acupuncture treatment for a patient. The system includes a hand-held electronic acupuncture device including a pressure sensitive, search probe having a pressure sensitive search probe operatively connected to the main unit, the search probe having a self-moistening probe tip adapted to apply pressure against the skin of a patient and to receive a current from the patient, the probe tip subject to moisture control so as to have consistent moisture and the search probe subject to pressure control so that the probe tip is applied with a constant pressure to a patient's skin, and a remote computing device, the electronic acupuncture device configured to communicate measurable patient data to the remote computing device for diagnosis or treatment of the patient.

Another example embodiment is directed to a handheld electronic acupuncture device. the device includes a handhold area operatively connected to a main electronics unit, the main unit including a display thereon and intelligence therein for providing one of diagnosis and/or treatment of a patient, a pressure sensitive search probe operatively connected to the main unit, the search probe having a self-moistening probe tip adapted to apply pressure against the skin of a patient and to receive a current from the patient, the probe tip subject to moisture control so as to have consistent moisture and the search probe subject to pressure control so that the probe tip is applied with a constant pressure to a patient's skin, and a grip probe operatively connected via an electrical connector to the main unit, wherein a patient grasps the grip probe and the search probe is applied to the patient's skin to complete an electrical circuit.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limitative of the example embodiments of the present invention.

FIG. 1 is an illustration of a hand-held electronic acupuncture device and system in accordance with an example embodiment.

FIG. 2 is a drawing of an example search probe for the acupuncture device in accordance with an example embodiment.

FIG. 3 is another example of a search in accordance with an example embodiment.

FIGS. 4A-4C illustrates example grip probe configurations for the electronic acupuncture device in accordance with an example embodiment.

FIGS. 5A and 5B illustrate an example Ryodoraku chart of a patient's Stimulation (STIM or excitation) and Sedation (SED or inhibition) points in accordance with an example embodiment.

FIG. 6A illustrates an enlarged view of a main unit assembly 115 of the hand-held electronic acupuncture device 100 in accordance with an example embodiment.

FIG. 6B is a circuit block diagram of part of the main electronic circuit in the hand-held electronic acupuncture device 100 in accordance with an example embodiment.

FIG. 6C is a circuit block diagram of part of the main electronic circuit in the hand-held electronic acupuncture device 100 including transmitter circuitry and diagnosis data display/indication circuitry, in accordance with an example embodiment.

FIG. 6D is a circuit block diagram of part of the receiver circuitry in the remote computing device 200, in accordance with an example embodiment.

FIG. 7A illustrates an enlarged view of a main unit assembly of a hand-held electronic acupuncture device in accordance with another example embodiment.

FIGS. 7B-1 and 7B-2 illustrate a circuit diagram of an electronic circuit included in a hand-held electronic acupuncture device in accordance with another example embodiment.

FIG. 8 is a flow diagram for describing a method of managing meridian energy data of a patient to treat the patient, in accordance with an example embodiment.

FIGS. 9A and 9B are screen shots illustrating exemplary data displayed to a user of the system in accordance with an example embodiment.

FIG. 10 is an enlarged top view of a search probe in accordance with an example embodiment.

FIG. 11 illustrates an exploded view of the search probe to show its constituent components.

FIGS. 12A and 12B illustrate user operation of the search probe.

FIGS. 13A to 13C illustrate user operation of the search probe.

FIGS. 14 through 16 illustrate pressure control with a moistened tip in accordance with other example embodiments.

FIG. 17 is a standalone view of a moisture-controlled tip.

FIGS. 18 and 19 are perspective and top views showing the tip attached to the search probe.

FIGS. 20 and 21 are photographs illustrating moisture applied by a search probe tip on a patient's skin.

FIGS. 22 to 24 illustrate other variations for moisture control in the search probe tip.

### DETAILED DESCRIPTION

A device that can diagnose acupuncture meridians may be a valuable medical device. Example embodiments herein describe features that may accelerate, simplify and/or improve the accuracy of diagnosis as compared to prior art devices. Moreover, and as to be explained in further detail hereafter, the example embodiments can enable a user with no prior acupuncture or meridian treatment skills to perform meridian treatment according to the Ryodoraku protocol.

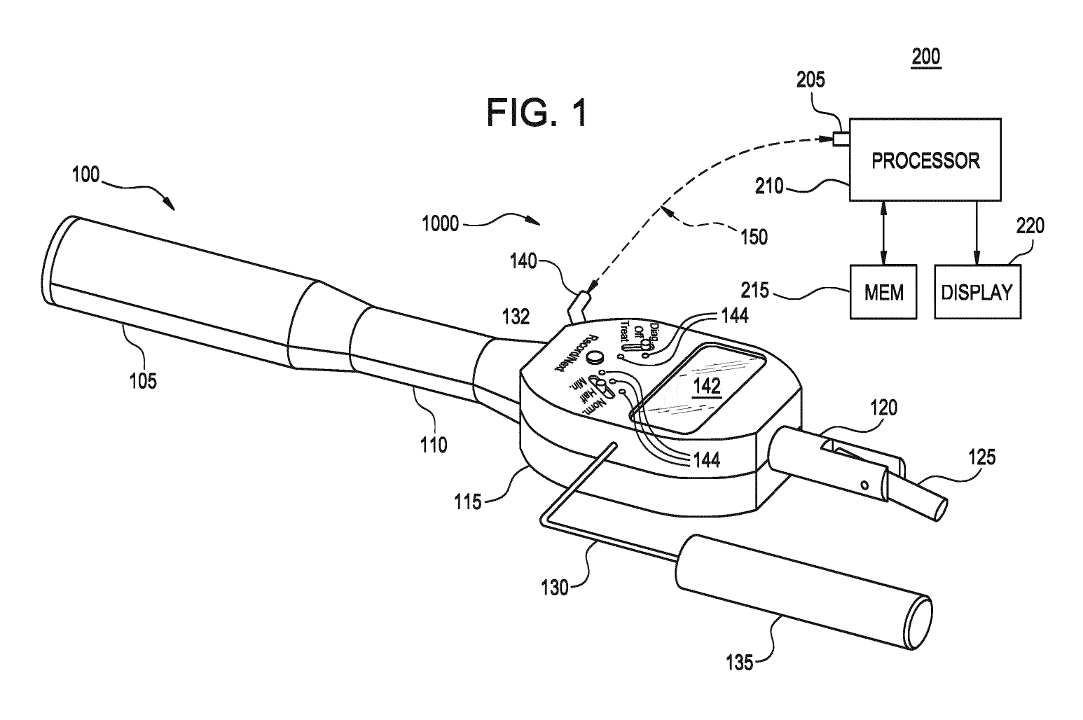

FIG. 1 is an illustration of a hand-held, electronic acupuncture device and system in accordance with an example embodiment of the present invention. Referring to FIG. 1, system 1000 may include an electronic acupuncture device 100 in operative communication with a remote computing device 200 via a wireless link 150 and a suitable user interface, for example. The remote computing device 200 may be embodied as a personal computer, work station or Personal Data Assistant (PDA) and/or integrated PDA/cell phone such as a Blackberry®, Treo® or Palm Pilot®, for example, it being understood that these are just a few of the exemplary intelligent devices which may be configurable as remote computing device 200.

The electronic acupuncture device (electronic device100) may include a power source compartment 105 as part of a handle 110 that is operatively connected to a main unit assembly 115. The power source may be embodied as a plurality of alkaline batteries or a plurality of rechargeable cells having any of nickel metal hydride (NiMH), nickel cadmium (NiCd) or lithium-ion (Li-ion) cell chemistry. The power source may also be embodied as a self-contained rechargeable battery pack, either in a standard size or customized for the electronic acupuncture device, and the device may be operable from a standard AC wall socket outlet or from a computing device, such as drawing power from its USB port via an adapter fx=, for example. An extension 120 extends from the main unit assembly 115 and houses a search probe 125. An electrical connector 130 may electrically connect a grip probe 135 to the main unit assembly 115 of the electronic device 100.

In general, the patient grips the grip probe 135 in their hand. A caregiver, who in an example may be the patient, grasps the handle 110 of the electronic device 100 such that the search probe 125 is pressed against the patient's skin. The caregiver may actuate a suitable switch 132 on the main unit assembly 115 to energize the electronic device 100 at a desired diagnosis voltage or desired treatment voltage, for example.

As will be described in further detail below, once activated, battery cells (not shown) within the power source compartment 105 of the electronic device 100 produce an output voltage through connector 130 and grip probe 135 into the patient's body, so as to generate a current (i.e., a ‘diagnosis’ current or a ‘treatment’ current, depending on the applied voltage) through the patient. The current travels through the patient's body, is received at the search probe 125 and flows into an electronic circuit (not shown) within device 100. The measured current may be read as a conductance value, for example, on a suitable display 142 of the electronic device 100, and/or may be communicated via an antenna of a transceiver (shown generally at 140) over a suitable air link 150 such as an RF link, to be received at the remote computing device 200.

In an example, display 142 may be embodied as a liquid crystal display (LCD) panel with color or an LCD with a black and white display. However, display 142 is not limited to an LCD, and alternatively may be embodied as a plasma display panel (PDP), a cathode-ray tube (CRT) display, an organic light emitting diode (OLED) display or any other known equivalent display device, for example.

In general, electronic device 100 may be integrated through a USB protocol, wireless or hard-wired protocol or other communication or data protocols, and/or with a software interface and/or data management system running on the remote computing device 200. The USB protocol is based on an external bus standard that supports data transfer rates of 12 Mbps. A single USB port can be used to connect up to 127 peripheral devices such as mice, modems and keyboards. USB also supports Plug-and-Play installation and hot plugging.

As discussed above, communication schemes between electronic device 100 and computing device 200 may be facilitated through USB ports, either hardwired or wireless, through another hard-wired protocol such as RS-232 or another wireless protocol such as Bluetooth, and/or through voice commands from a user. Other alternative example wireless communication protocols may be based on one or more of CDMA (IS95, cdma2000 and various technology variations), UMTS (releases 99, R4, R5, R6 and above), GSM, 802.11 and/or related spread-spectrum based wireless technologies.

Various modifications will be apparent to those skilled in the art for application to communication systems or networks accessible by system 1000 based on technologies other than the above, which may be in various stages of development and intended for future replacement of or use in conjunction with the above communication networks or systems.

As shown in FIG. 1, the remote computing device 200 may include corresponding transceiver circuitry (shown generally at 205) for receiving the data and processing the patient current data therein in a suitable processor 210 such as any of the Pentium® line of microprocessors by Intel®, for example. An example transceiver 140/205 may be a Model TR105 miniature wireless transceiver by OTEK™ Corp., or similar embedded transceiver. In an example, processor 210 may be operatively connected to a memory 215 and to a display 220.

Accordingly, measurable data (such as the patient's current or conductance values reflective of the current) may be packetized in the transceiver 140 and transmitted as part of one or more packets of data wirelessly over air link 150 to an antenna at transceiver 205 operatively connected to the remote computing device 200. Alternatively, the measurable data may be transmitted over hard-wired protocols. The received data may be down-converted and demodulated as is known, and forwarded to downstream processing circuitry within processor 210.

The electronic device 100 and associated electronic circuitry therein may be powered from a suitable power source within compartment 105 such as a plurality of alkaline batteries, i.e., 4 “AA” size batteries, or by a plurality of rechargeable, removable battery cells or a rechargeable battery pack having one or more cells. Rechargeable secondary batteries for powering portable electronic devices are well known, evidenced by the battery packs used to power low-voltage devices such as cell phones, personal digital assistants (PDAs) and/or laptop computers. Accordingly, suitable power supplies may be battery packs consisting of one or more cells or batteries having any of a nickel metal hydride (NiMH), nickel cadmium (NiCd) and/or Li-ion cell chemistry with associated electrolyte. The cells may have either a cylindrical or prismatic construction depending on the shape and/or width of the power source compartment 105 and handle 110, for example.

A power source of NiMH, NiCD or Li-ion batteries or cells may be rechargeable via a battery charger. The battery charger typically includes a recharging stand or cradle to provide an AC source of charging current. The AC source may be provided from one of a wall outlet (i.e., via a plug) or from a computing device.

An example charger may be a charger having on-board electronics or intelligence, such as the MH-C2000™ universal battery charger by MAHA Energy Corp.™ for example, although chargers which do not support multiple chemistries are also applicable. The MH-C2000™ is capable of charging a wide selection of battery packs, such as four AA or AAA NiMH and NiCD battery cells at a time. An example charger such as the MH-C2000™ may include built-in support for Li-ion, NiMH and NiCD rechargeable battery pack chemistries, and may be configured to automatically detect battery pack type and battery voltage. An embedded microprocessor may be included therein to constantly monitor the charging process in an effort to prolong battery life, and/or for communication with external electronic devices.

The electronic device 100 may be configured to have battery pack terminals (e.g., rail-style or tower-style terminal configuration, as is known in the art) within compartment 105, which may be exposed at an end thereof for matingly engaging charger terminals in the cradle or stand of the battery charger. In additional to power terminals, an example battery pack within device 100 may have sense and/or communication terminals for communication with corresponding terminals in the charger. Accordingly, the battery charger in one example may be configured to upload data stored in the electronic device via communication terminals to the charger, for transmission or communication to an external computing device such as remote computing device 200, for example.

In an example, the remote computing device 200 may be embodied in hardware and/or software to include a digital microprocessor within a suitable personal computer that includes a wireless hub and associated transceiver components and circuitry. However, instead of a digital microprocessor, an analog processor, digital signal processor, one or more programmable integrated circuits, and/or one or more application specific integrated circuits (ASICs) controlled by a suitable microcontroller or microprocessor may be used in lieu of a digital microprocessor in the remote computing device 200. Power to the remote computing device 200 may be provided by a suitable AC power (line) source or by a rechargeable battery pack as described above.

As shown in FIG. 1, the electronic device 100 includes a plurality of LEDs which in general are indicative of given voltages applied within device 100 so as to generate the desired voltage to the patient. As will be described in further detail below, a dedicated LED may represent generation of a diagnosis voltage within the electronic circuit therein and another dedicated LED may represent a treatment voltage being generated by the electronic circuit of device 100. Selection of a diagnosis or treatment voltage to be output by the power source through the patient via grip probe 135 may be effectuated via user manipulation of given switches 132, 134, which in an example may be double-position, double-throw (DPDT) switches.

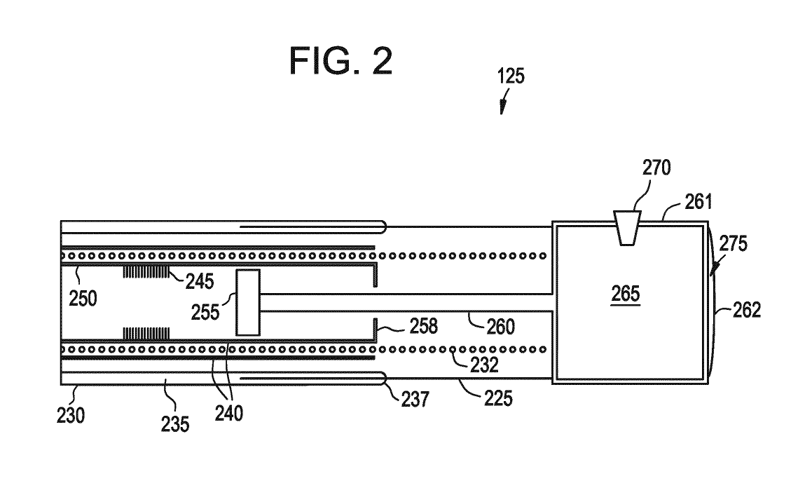

FIG. 2 is a detailed illustration of the search probe 125 of the acupuncture device in accordance with an example embodiment of the present invention. Referring to FIG. 2, the search probe 125 may include a plastic cylinder 230 as an outer shell, which may provide mechanical support for a hammer head 261 of the search probe 125. The plastic cylinder 230 may be of a suitable thickness and may be molded into a metal base, for example.

The search probe 125 may include a plurality of inner cylinders 240 which may be formed of a suitable plastic material. Cylinders 240 may be connected to a metal hammer base 250. A spring 232 may connect the hammer base 250 with a hammer head tip 262. A groove 235 in the plastic cylinder 230 may allow for motion of a moving cylinder 225. A tip 237 of the plastic cylinder 230 may be a ring that provides a mechanical boundary of the hammer head tip 262 longitudinal motion. As shown in FIG. 2, the moving cylinder 225 may provide mechanical support to the hammer head tip 262 and slide within the cylinder 230 along the longitudinal axis of cylinder 230.

As shown in FIG. 2, for electrical connection a metal brush ring 245 may be provided, in which the electrical connection between the brush ring 245 and the hammer base 250 is sealed within a suitable plastic. A metal plunger head 255 is configured to make electrical connection with the brush ring 245 and may also act to restrict the hammer head tip 262 from being ejected.

A plastic annulus 258 may permit plunger rod 260 motions and provides the mechanical boundary for the plunger head 255 longitudinal motion, as shown in FIG. 2. Plastic annulus 258 also provides a boundary for a fluid such as oil for dampening the motion of plunger head 255. Plunger rod 260 may be a conducting metal and may provide mechanical support, providing electrical connectivity with the plunger head 255.

The hammer head 261 may be composed of a conducting metal, but may also have a hollow interior with a reservoir 265 configured to hold a suitable fluid to facilitate transfer of current from the patient into an electronic circuit of the electronic device 100. Accordingly, the search probe 125 may exhibit a self-wetting feature. As shown in FIG. 2, a screw 270 may be removed and/or inserted so as to allow (or prevent) fluid flow into or out of the reservoir 265. The hammer head 261 may include a semi-permeable material 275 or other material with substantially small or microscopic holes serving as a fluid filter at tip 262. This may permit constant moisture at the tip 262, for example. The source of the constant moisture may be the fluid constrained within reservoir 265, for example, or it may include a suitable pipe or flexible hose connection to a larger reservoir located elsewhere on the electronic acupuncture device 100 (not pictured).

In an example, the interface where the search probe 125 is attached to the main unit 115 may be waterproofed. In another example, the search probe 125 may be rotatable and may be adapted so as to lock in place in a particular position or orientation. In a further example, the search probe 125 may include a pressure sensitivity mechanism for tip 262 (not shown).

In another aspect, tip 262 could be provided with an insulating cover (not shown) to limit current during treatment. For example, a number of different covers could be provided to attenuate or lower current felt by the patient, depending on the patient's comfort. Although not shown in FIGS. 1 and 2, electronic device 100 could be provided with alligator clips to provide voltages that generate currents through the patient for a potential needling acupuncture application.

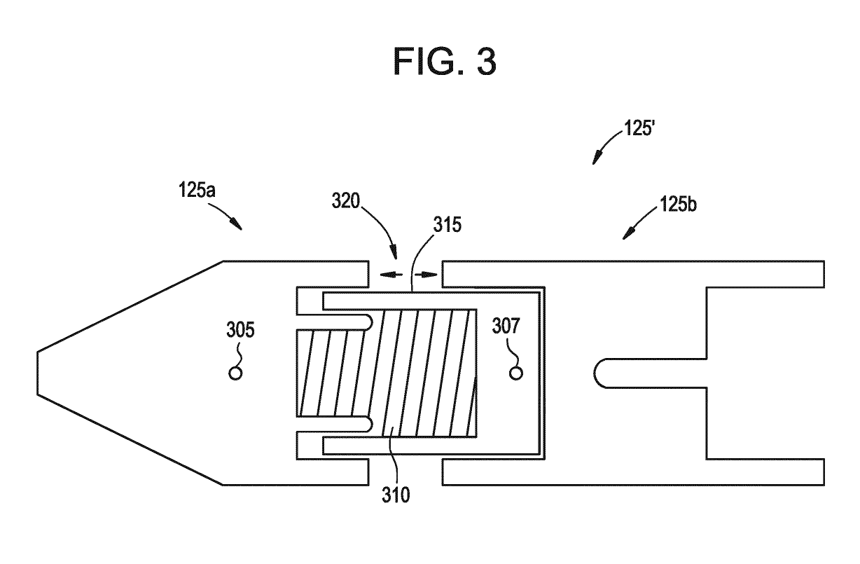

FIG. 3 is another example of a search probe in accordance with an example embodiment of the present invention. FIG. 3 shows a cut-away side view of a search probe 125′. In FIG. 3, search probe 125′ has a two piece construction, a distal probe end 125a and a proximal end 125b that is connectable to extension 120 (not shown) via rotation point 307 be suitable fastening means such as a pin, screw, etc. The distal probe end 125a is attachable to the proximal end 125b at rotation point 305 via suitable fastening means.

The probe 125′ provides pressure control by use of a spring 310 within a non-conductive cylinder 315 that is situated between the distal and proximate ends 125a, 125b. A counter spring force is exerted against the direction of pressure of the probe tip 362 against the patient. This causes the spring to compress, narrowing gap 320 between ends 125a, and 125b. The caregiver or patient has an indication of a proper pressure once the metal surfaces of the ends 125a, 125b engage or touch, such that an electrical path is established and a proper current measurement can be made. Accordingly, the arrangement in FIG. 3 may permit current to flow when a minimum pressure is applied, which, while not preventing the user from applying too much pressure, may help the user apply an accurate pressure.

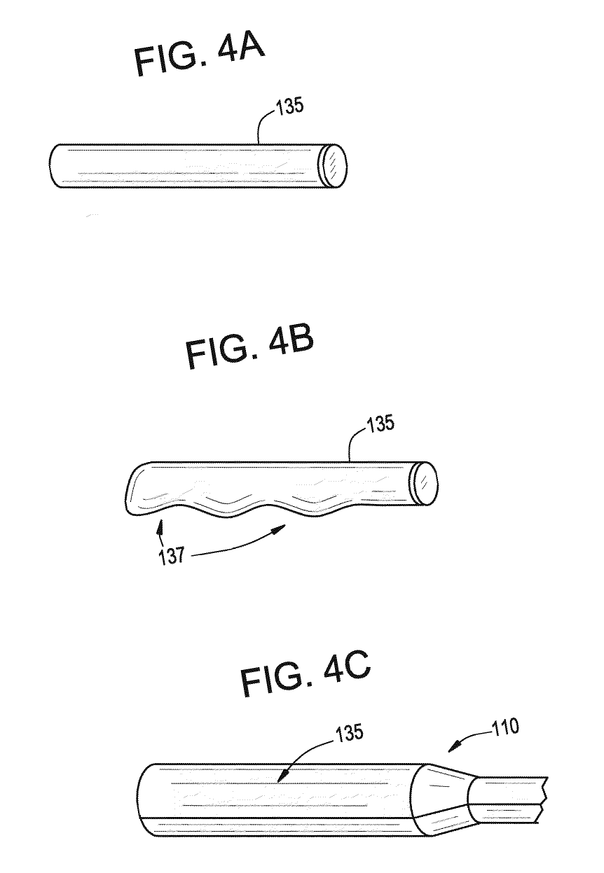

FIGS. 4A-4C is diagrams of example grip probe configurations for the electronic acupuncture device 100 in accordance with an example embodiment of the present invention. FIG. 4A illustrates an example grip probe 135, which may be embodied as a generally cylindrically-shaped object. Grip probe 135 may be substantially hollow to reduce weight. Grip probe 135 may be composed of a suitable conductive metal or non-metal material. Example conductive metals for grip probe 135 may include but are not limited to copper, silver, brasses, leaded brasses, bronzes, copper-nickel alloys, nickel slivers, special bronzes, and alloys of one or more of these metals, and conductive plastic compounds, for example. Although not shown in the figures, a moist or water-permeable and removable slip cover may be placed over grip probe 135 to wet the patient's hand and further promote electrical conduction of current through the patient's body. Alternatively, the patient may periodically wet their hand.

Referring to FIG. 4B, in another variant the grip probe 135 may include finger grooves or indentations 137 for improved grip. The grip probe 135 in FIG. 4A or 4B may in one example have a variable width means (not shown) to set the grip probe width as desired to facilitate grasping by the patient. Accordingly, grooved finger-grip surfaces or indentations 137 as shown in FIG. 4B may facilitate grasping of the grip probe 135 by the hand of the patient.

In FIG. 1 a search probe 125 and a grip probe 135 are used by the patient/caregiver to complete a circuit through the patient. However, the example embodiments herein envision an alternative arrangement for single person use (e.g., the caregiver is the patient). Referring to FIG. 4C, in this alternative construction the grip probe 135 (e.g., ground electrode) may be merged into the main unit handle 110 area to allow one-handed operations. Thus, the ground electrode would become part of handle 110 that is operatively connected to a main unit assembly 115. This would eliminate the need for an electrical connector 130 to electrically connect a grip probe 135 to the main unit assembly 115 of the electronic device 100. The handle 110 would thus serve two-purposes: structural support and providing a ground to complete an electric circuit for one-handed operation.

Alternatively, in another example embodiment of an electronic device having onboard intelligence to be described hereafter, the intelligent device may be adapted for use with gloves, socks, and/or straps, adhesive or other means of securing fibers containing electronic conductors to the patient's skin. This may provide for automated application of the diagnosis voltages to the diagnosis points and automated measurement of the diagnosis currents generated in the patient (not pictured).

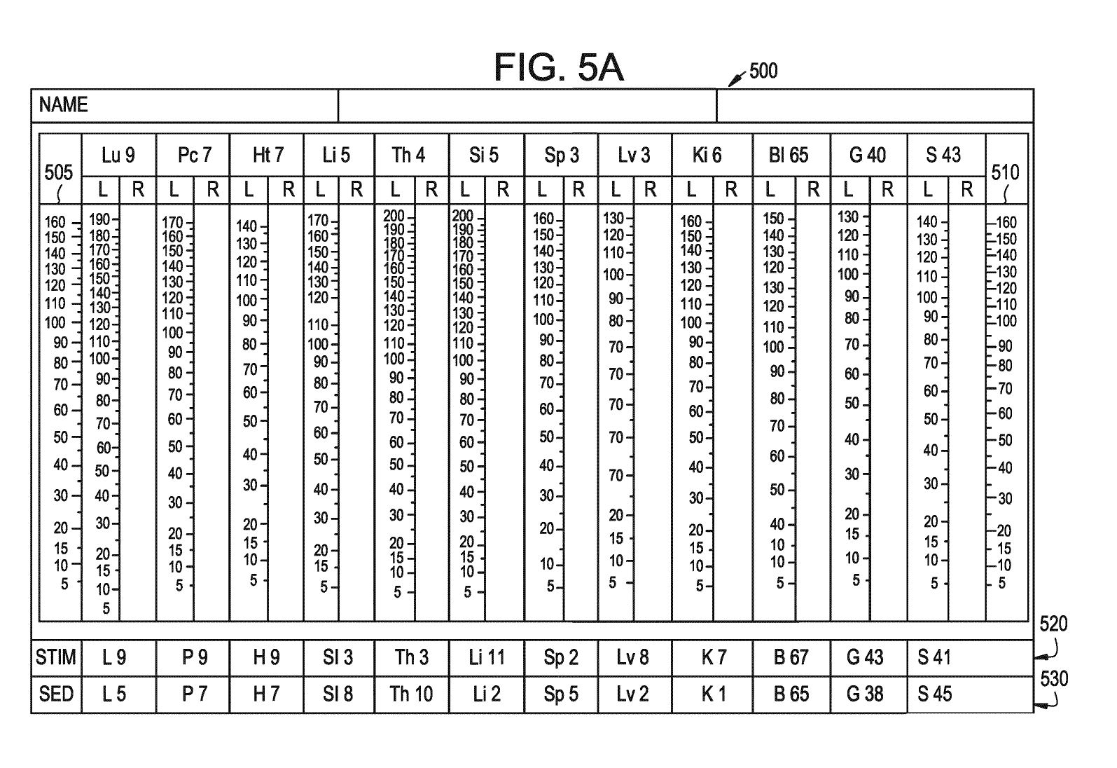

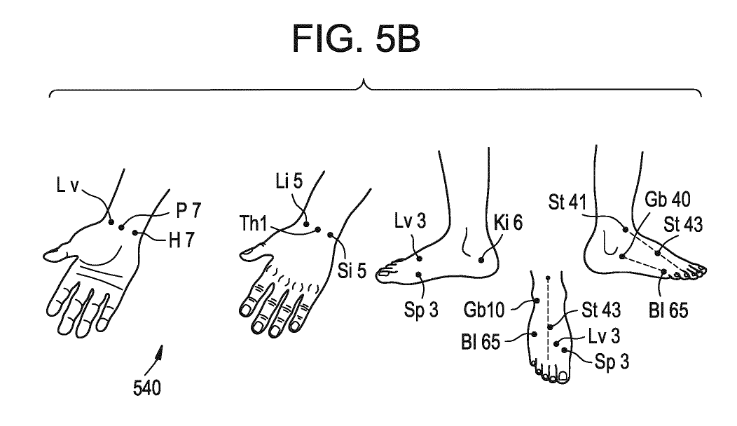

FIGS. 5A and 5B illustrate an example Ryodoraku chart 500 of a patient's Stimulation (STIM) and Sedation (SED) points in accordance with an example embodiment of the present invention. As discussed above, software at the remote computing device 200 may implement a desired protocol for graphically displaying a plurality of data points corresponding to the received current measurement from the patient. An example protocol is the Ryodoraku protocol, although the example embodiments may utilize protocols of other acupuncture and/or meridian-type analyses. For a more detailed discussion of the Ryodoraku protocol, reference may be made to the text by Nakatani et al. entitled “Ryodoraku Acupuncture”, Ryodoraku Research Institute, Ltd., Tokyo, Japan, published Jul. 9, 1977. The relevant portions of the Nakatani et al. text which describe the Ryodoraku protocol are hereby incorporated in their entirety herein by reference.

The example embodiments of the present invention digitally transcribe, to software algorithms, the complex diagnosis graph created by Nakatani et al. in order to enable diagnosis calculations accurate to the Ryodoraku protocol. The visual representation of the diagnosis data may be simplified and/or normalized to a bar chart, for example, to facilitate understanding of the displayed data. The diagnosis data may be displayed on such a chart in real time as diagnosis measurements are taken. In another example, Nakatani et al.'s ‘Hand 1 (H1), Hand 2 . . . Foot 1, Foot 2 . . . Foot 6 ’ shorthand notation may be replaced with displayed notations such as ‘Lung 9 (Lu9)’ that are more descriptive of the points being measured on each meridian. This may simplify choices of recommended treatment points to sedate or excite certain meridians by recommending the most potent treatment point, instead of recommending multiple treatment points as described in the Nakatani et al. text.

As shown in FIG. 5A, the example Ryodoraku chart 500 shows a plot of patient current (conductance values) in each of twelve (12) interior columns The left most and right most columns 505, 510 of the chart 500 are for plotting average current for the patient. A current point (represented as a conductance value) is plotted on the right and left sides of each of the interior 12 columns, corresponding to right and left sides of the patient's body, for a total of 24 points.

As shown on the lower portion of the chart in FIG. 5A, the STIM rows 520 are points used to stimulate the patient and the SED rows 530 are points used to sedate the patient. STIM and SED points represent part of the treatment portion of the patient using the electronic acupuncture device 100. Graphical representations (540) of the approximate locations of the 12 major energy meridian points on the hands and feet of a human being are illustrated at the bottom of chart 500, as shown in FIG. 5B. This may be used by the caregiver or patient for reference.

In an example, the electronic acupuncture device 100 is configured so as to provide a simpler mechanical system to apply the desired or optimal pressure to a patient's skin. The use of a brush ring and hammer base subassembly as shown in FIG. 2, for example, provides a more efficient, simpler and less expensive mechanical solution for applying the desired pressure in order to generate more accurate current data for the Ryodoraku protocol evaluation at the remote computing device 200. The arrangement in FIG. 2 permits current to flow through the search probe 125 only when pressure applied to the patient's skin is within a given range, as determined by the compression of a spring 232. Alternatively, the arrangement in FIG. 3 may permit current to flow when a minimum pressure is applied, which, while not preventing the user from applying too much pressure, may assist the user in applying an appropriate pressure to get a more accurate reading.

The example system may thus provide a noninvasive acupuncture treatment in which a hand-held electronic acupuncture device 100 is powered by a self-contained power source and includes an ammeter, i.e., a “smart probe”. Accordingly, device 100 is flexible and may better serve a patient's and/or caregiver's needs. The search probe 125 may be rotatable and/or may include swiveling features which provides ease of use. In FIG. 2, the search probe 125 includes a self-moistening tip 262 to ensure proper electrical conduction of the patient's internal body current into the electronic device 100. This may provide a truer and more accurate indication of measured patient current, and may more accurately indicate the flow of stimulating or sedating current in the patient in a manner readable by the patient or caregiver, either on a suitable display 142 of the electronic device 100 or on a display 220 of the remote computing device 200.

Wireless connectivity between the electronic acupuncture device 100 and the remote computing device 200 may thus provide a system 1000 that is highly flexible, and which can provide data that may be read remotely in the patient's room within a hospital, and/or at other locations around the world, for proper diagnosis and follow-on treatment. Operation and navigation through the software on the remote computing device 200 may be designed to be accomplished wirelessly through the electronic acupuncture device 100, so that the user can render diagnosis, store and view patients' present and historical diagnosis data, and render treatment with the aid of software by using one button, such as a ‘record/next’ button on the device 100. Thus, the user does not have to use the remote computing device 200's controls.

In another aspect, the Ryodoraku protocol may be implemented by software executed at the remote computing device 200 so as to properly diagnose the patient by running and measuring the low-level current at 12V DC through 24 points around the wrist and/or feet. The applied diagnosis voltage may produce a current ('diagnosis current') through the patient in the 0 to 200 μA range, and the 24 points may be measured utilizing the graphical Ryodoraku protocol. As shown in FIG. 5A, the data may serve as inputs to a normalized graph 500 to compare the 24 points and produce a recommendation for stimulating or sedating the patient's energy meridians. Thereafter, the caregiver may stimulate points on the patient's body corresponding to the graph's recommendations. If desired, one or more post-treatment readings may be taken to verify that the energy meridians are balanced. Moreover, the graphical representation illustrated in FIG. 5 may be implemented in software for display and analysis on one of display 142/220.

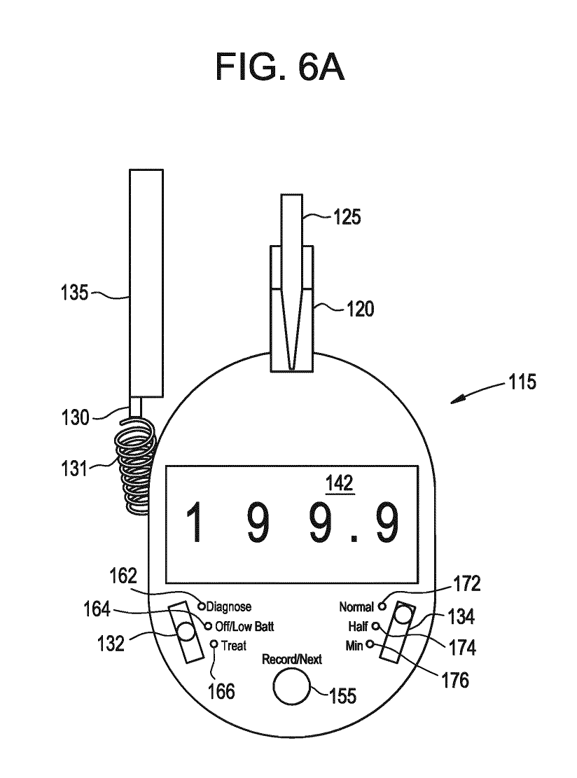

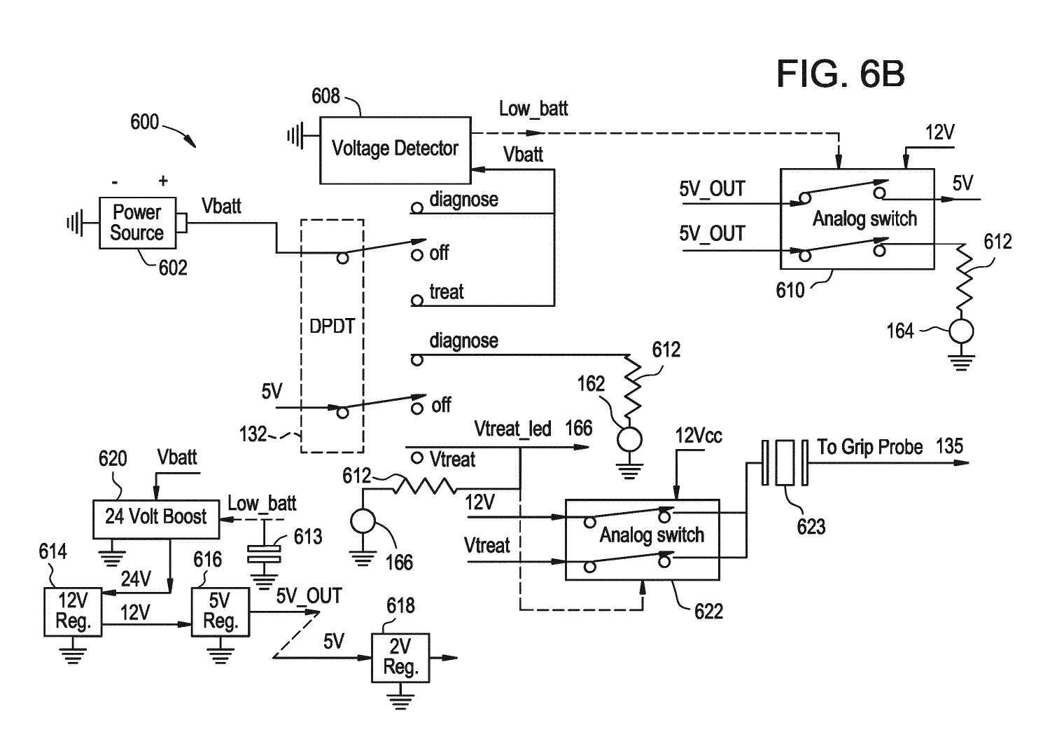

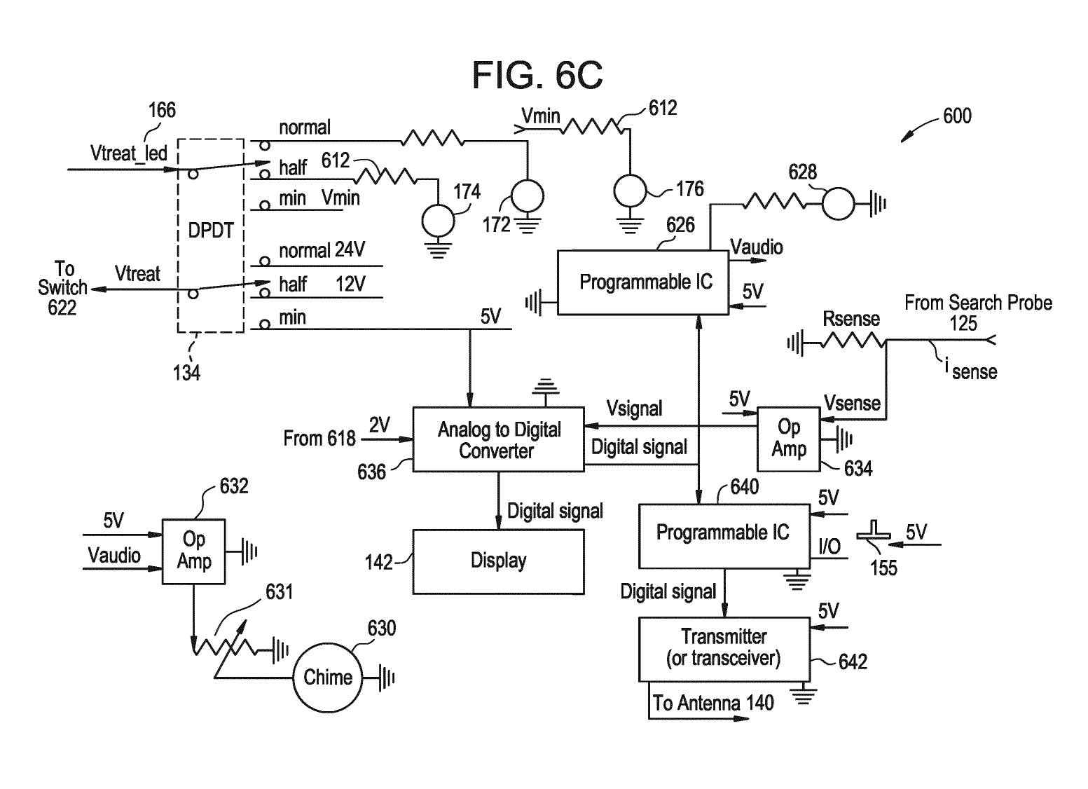

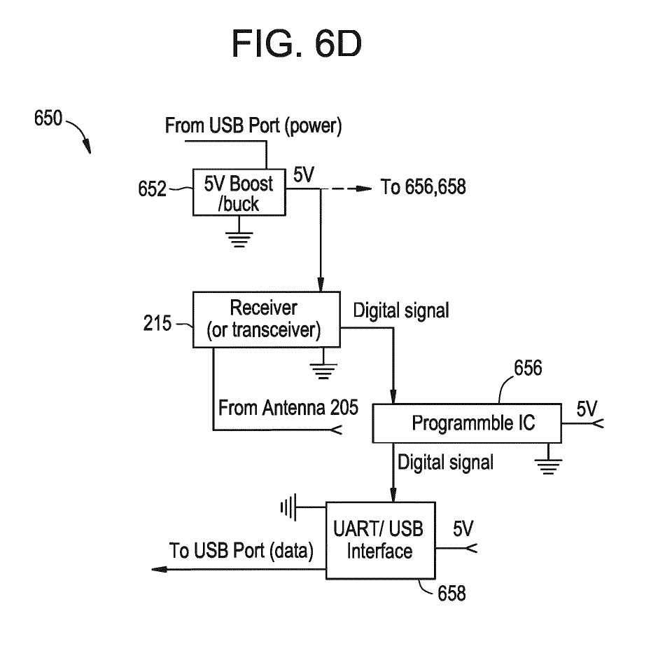

FIG. 6A illustrates an enlarged view of the main unit assembly 115 of the hand-held electronic acupuncture device 100 in accordance with an example embodiment of the present invention. In FIG. 6A, only the main unit 115, search probe 125 and grip probe 135 of the electronic device 100 are shown for purposes of clarity.

The main unit 115 includes a user-manipulated on/off switch 132 such as a DPDT switch that is movable between off, treatment and diagnose as indicated by LEDs 162, 164 and 166 on the main unit 115. Additionally switch 134 may be provided to vary or change the amount of treatment voltage applied between a normal (24 volts), half (12 volts) and minimum (5 or 6 volts) voltage level, so as to provide a variable treatment voltage to the patient. These voltage levels may be indicated on the main unit 115 by corresponding LEDs 172, 174 and 176. Other example voltage levels may include voltages above 6 volts or the ability for a user to select diagnosis and/or treatment voltages of their choosing over a range of about 5 to 30 volts, for example.

In this example, the main unit 115 does not include onboard intelligence such as an embedded microprocessor, but rather communicates data to the remote computing device 200 via suitable communication means. As shown in FIG. 6A, the grip probe 135 may be attached to the main unit 115 via a connector 130. The connector 130 may be part of an expandable spring 131 which allows the patient to grasp the grip probe 135 and pull it away from the main unit 115 for diagnosis and/or treatment. As shown in FIG. 6A, the LEDs for treatment and normal voltage (24V) are illuminated, to show that a normal 24 volt treatment voltage is being applied to the patient. Additionally, main unit 115 may include a record button 155 which enables the patient or caregiver to record measurable data, which may be communicated to the remote communicating device 200.

FIG. 6B is a circuit block diagram of part of a main electronic circuit 600 in the hand-held electronic acupuncture device 100, and FIG. 6C is a circuit block diagram of another part of the main electronic circuit 600 including transmitter circuitry, in accordance with an example embodiment of the present invention.

Referring to FIGS. 6B and 6C, the switch positions diagnose, off and treatment are shown in relation to the power source 602 within the power source compartment 105. Depending on which is selected (as indicated by LEDs 162 or 166, for example), one of a 24 volt, 12 volt or 5/6 volt voltage may be applied. In the diagnosis state or mode, a 12 volt voltage may be applied via regulator 614, high speed analog switch 622 (shut based on the logic signal dotted line from the switch 132) and current limiter 623 to generate a voltage (e.g., v_{diag}=12V) through the grip probe 135 and into the patient, to generate a diagnosis current that is measurable iₛₑₙₛₑ, at search probe 125. In the treatment state or mode, actuation of switches 132 and 134 send logic signals (dotted lines) to shut analog switch 622, and to illuminate LED 166 and one of LEDs 172, 174 or 176.

In general, the analog signal received from the patient serves as an input (V_{signal}) to ADC 636 for conversion to a suitable digital signal for display on LCD 142. Additionally, the digital signal is formatted by a programmable IC 640 for transmission by transmitter/transceiver 642 via antenna 140 over air interface 150 (FIG. 1) or other interface (if wired, via wired connection to a USB) to be received, processed/analyzed and/or displayed on the display 220 of the remote computing device 200. As an example, actuation of the record button 155 permits this processing to take place.

High speed analog switches 610 and 624 may be existing off-the-shelf components. Example high speed analog switches usable in main circuit 600 may be those such as the Maxim dual, 5Ω analog switches from Dallas Semiconductor®, part numbers MAX4622 and MAX4623. High speed analog switches 610 and 624 are more robust for low-distortion applications or applications where current switching is required, as compared to mechanical relays. High speed analog switches have generally low power requirements, use less board space and are generally more reliable than mechanical relays, and may be operable from either a single positive supply (i.e., power source 602) or with bipolar supplies, while retaining CMOS-logic input compatibility.

Main electronic circuit 600 may include regulators 614, 616 and 618. Regulator 614 regulates the 24 volt bus voltage output from 24 volt boost circuit 620 down to the 12 volt diagnosis voltage applied to the patient, or to a “half treatment” voltage if switch 134 is selected to half. Regulator 616 may be provided to generate the Vcc for the switches (5V_out) from the 12V output from regulator 614, 5V power for DPDT switch 132, programmable integrated circuits (ICs) 626, 640, op amps 632 and 634 and transmitter 642. Regulator 618 generates a 2V reference voltage for the ADC 636 from the 5V voltage output from regulator 616.

Based on Vbatt and Vdd input thereto, the 24V boost circuit 620 generates a 24V output, which may be input to switch 622 as the normal treatment voltage (Vₜᵣₑₐₜ) used to generate iₜᵣₑₐₜ in the patient (when switch 134 set to normal), or which may regulated by regulator 614 or 616 to a lower treatment voltage (12V (half), 5/6 volts (min)) As shown in FIGS. 6B and 6C, given LEDs 162, 164, 166, 172, 174 and 176 are illuminated based on the position of switches 132 and 134. Resistors 612 are provided as voltage dividers for the LEDs.

Main electronic circuit 600 may include a voltage detector 608, which in an example may be a programmable IC. Voltage detector 608 may be programmed to detect a high voltage condition (6VDC —indicating that an incorrect power source is inserted) or a low voltage condition (˜3VDC) in the power source 602, so as to take a protective action by sending the appropriate logic signal (see dotted line in FIG. 6B) to shut analog switch 610, energize LED 164 and cutoff 24V boost circuit 620. LED 164 may be illuminated in conjunction with an audible alarm to alert the user of the high/low voltage condition. For example, PIC 626 generates a digital \V_{audio} signal that is input to op amp 632. The output from op amp 632 is varied by potentiometer 631, so as to produce a variable pitch at chime 630 alerting the user. The low_batt logic signal thus shuts switch 610, cuts out 24V boost circuit 620 and illuminates LED 164. A capacitor 613 is provided in the low_batt input to 24V boost circuit 620. The capacitor 613 acts as a delay, storing charge to allow analog switch 610 to toggle and shut before to low_batt input signal cuts off the 24V boost circuit 620.

Referring to FIG. 6C, the current (iₛₑₙₛₑ received from the patient (via search probe s-sense, 125) in response to the applied diagnosis or treatment voltage from grip probe 135 is converted into an analog voltage signal Vₛₑₙₛₑ via resistor Rₛₑₙₛₑ, as is known, and input to operational amplifiers 632 and 634 for comparison to the reference voltage so as to generate an amplified signal (V_{signal}).

V_{signal} is input to programmable IC 626 and ADC 636, which converts the readings to a digital signal that may be displayed as a conductance value on display 142. Programmable IC 626 (and 640) may be off-the-shelf components such as 8/14 pin, 8-bit flash microcontrollers fabricated by Microchip Technology, Inc.®, part number PIC12F509, although other ICs having non-volatile memory may be used, as is evident to one skilled in the art.

As discussed, programmable IC (or PIC) 626 functions to control a point location (visual) indicator LED 628 and the variable frequency chime 630 (audible indicator), based on the value of V_{signal}. For example, as the caregiver is moving the search probe around a given meridian energy point as shown in FIG. 5, the display 142 (LCD) will display a rapidly changing current. The PIC 626 illuminates the LED 628 at the highest local current in the vicinity of the measured meridian energy point on the patient's body. The frequency of the chime 630 gradually changes from a lower frequency pitch (via potentiometer 631) to a higher frequency pitch (and vice versa) (as V_{signal} increases/decreases due to higher/lower measured instantaneous current) to assist the caregiver in locating the correct meridian point to record data.

Once that point is reached, the user depresses actuation button 155 to temporarily record the data in flash memory. The V_{signal} corresponding to the recorded data is also converted at ADC 636 into a digital signal that is displayed at LCD 142 and converted into a suitable format at PIC 640 for transmission as an RF signal (after appropriate modulation and coding at transmitter/transceiver 642) via the antenna 140 to the remote computing device 200 over air link 150 (or alternatively via a wired interface such as a USB cable, if such is connected between electronic device 100 and remote computing device 200). Although two PICs 626 and 640 are shown in FIG. 6C, the functions of LED 625, chime 630 and transceiver 642 could be controlled from a single PIC 626 or 640.

FIG. 6D is a circuit block diagram of part of the receiver circuitry in the remote computing device 200, in accordance with an example embodiment of the present invention. Receiver circuitry 650 may be powered via a 5V signal from a boost/buck circuit 652 which receives power from a USB port of the remote computing device 200. The 5V signal may be used to power receiver/transceiver 215 (FIG. 1), PIC 656 and UART/USB interface 658.

Transceiver/receiver 215 demodulates and decodes the RF signal received over its antenna into a digital signal that is input to PIC 656. PIC 656 changes the format of the digital signal into a format suitable for the UART/USB interface 658. A Universal Asynchronous Receiver/Transmitter (UART) controller is a computer component that handles asynchronous serial communication. Every computing device contains a UART to manage its serial ports; some internal modems have their own UART. For example, a 16550 UART contains a 16-byte buffer, enabling it to support higher transmission rates than the older 8250 UART.

The UART/USB interface 658 may be an off-the-shelf component such as a CP2102 single-chip USB to UART bridge by Silicon Laboratories®, for example. The UART/USB interface 658 converts data traffic between USB and UART formats so as to separate bytes into individual bits which are transmitted ins sequential fashion to non-networked entities such as processor 210, for example, via a suitable serial data port (USB), for storage in a suitable memory 215, for display on display 220 for analysis by the caregiver, and/or for processing/analysis by processor 210 executing a specified software routine or algorithm, for example.

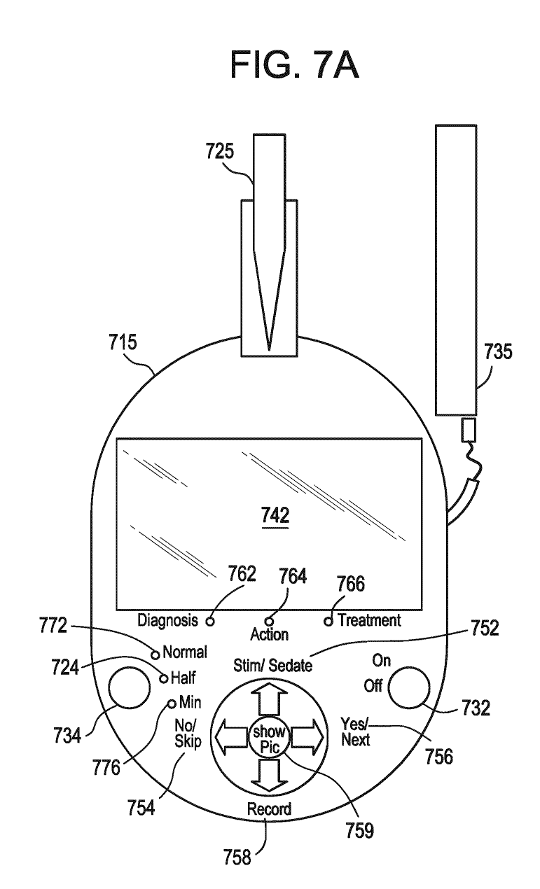

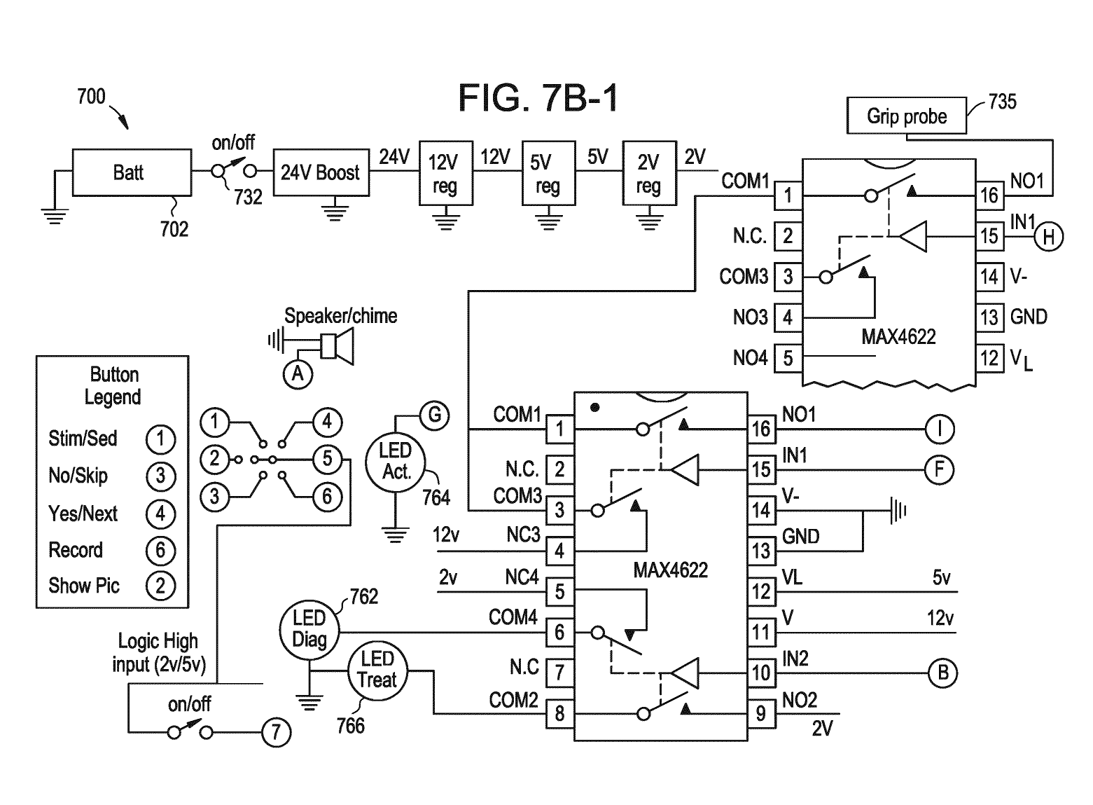

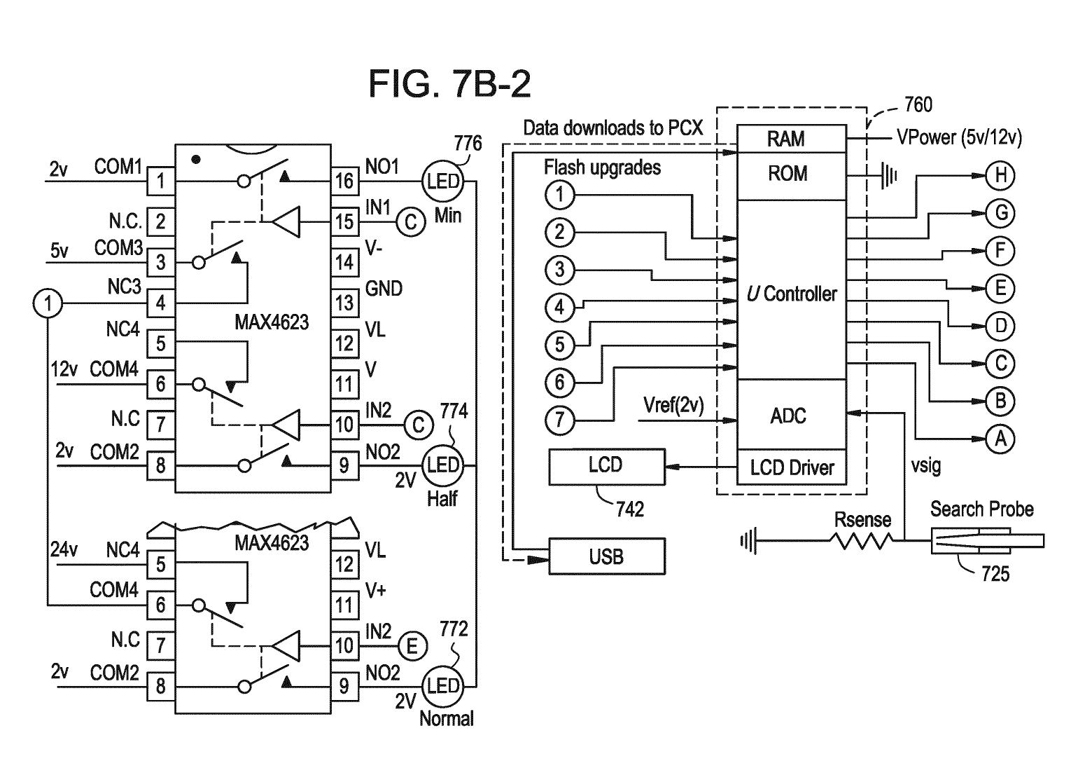

FIG. 7A illustrates an enlarged view of a main unit assembly of a hand-held electronic acupuncture device in accordance with another example embodiment of the present invention. FIG. 7A is somewhat similar to FIG. 6A, however, the main unit 715 in FIG. 7A is provided with onboard electronics/intelligence, as to be discussed hereafter. Referring to FIG. 7A, main unit 715 may include a display 742 such as an LCD panel (or equivalent display medium), and may be operatively connected to the grip probe 735 and search probe 725. The main unit 715 may include an on/off button 732 (alternatively this may be a switch) and a button/switch 734 for selecting between normal, half and minimum treatment voltages.

Additionally, the main unit 715 may be provided with a multi-function actuation button 750. The multi-function actuation button 750 may include a number of button positions, including stim/sedate 752, a no/skip selection position 754, a yes/next selection position 756, a record position 758 and a show pic (short for “show picture”) selection button 759. In an example, multi-function actuation button may be a four-directional, center-push, multifunctional SKRH-series TACT switch. Also as shown in FIG. 7A, LEDs 772, 774 and 776 can be provided for each of the normal, half and minimum treatment voltages. Main unit 715 may include an action LED 764 and treatment and diagnosis LEDs 762, 766.

FIGS. 7B-1 and 7B-2 illustrate a circuit diagram of an electronic circuit included in a hand-held electronic acupuncture device in accordance with another example embodiment of the present invention. As shown in FIGS. 7B-1 and 7B-2, the circuit diagram is of an electronic acupuncture device with intelligence. In this example, the intelligence may be embodied by an integrated semiconductor device such as a microchip 760. The microchip 760 may include a memory unit comprised of RAM and ROM or combinations thereof, a processor (microcontroller) an ADC and an LCD driver, for example. The individual inputs and outputs labeled “A-I” in FIG. 7B-1 are shown between the chip 760 and various other semiconductor devices which may comprise the electronics of the main unit 715. The following Table 1 illustrates certain example functional processing steps and explains the user interaction, result and feedback to user. Table 1 should be read with occasional reference to each of FIG. 7A and FIGS. 7B-1 and 7B-2.

TABLE 1
Functionality Chart corresponding to FIGS. 7A and 7B-1/2

| User Control | What Happens | Feedback to User |
|---|---|---|
| Presses ‘On/Off’ button | Circuit 700 turns on in | LED 762 illuminates beside |
| 732 | Diagnosis mode | ‘Diagnosis’ |
| | Clear all RAM/buffers to | LCD 742: ‘Yes/Next to |
| | zeros/defaults | diagnose’. |
| | Unit 715 places 12 V across | LCD 742: ‘No/Skip for |
| | probes 725, 735 and holds it | advanced.’ |
| | during diagnosis mode | |
| Presses ‘Yes/Next’ 756 | Remains in diagnosis mode | LCD 742: ‘Begin |
| | | diagnosis’ |
| | | LCD 742: Lu9R |
| Presses ‘No/Skip’ 754 | See 1* below | |
| 1* Presses ‘Show Pic’ | Unit 715 replaces | LCD 742: illustration of |
| button 759 during | characters on screen with | recommended point |
| diagnosis mode while the | illustration | |
| unit 715 is displaying the | | |
| name of a recommended | | |
| point to be treated (i.e | | |
| Lu9R) | | |
| 5 seconds elapse after | Unit 715 replaces | LCD 742: data that was on |
| ‘Show Pic’ 759 pressed per | illustration with data from | screen prior to pressing |
| conditions above | prior screen | ‘Show Pic’ button 759 5 |
| | | seconds ago |
| 3*Places search probe 725 | Current flows from grip | LCD 742: real-time |
| on patient | probe 735 through patient | current value |
| | to search probe 725 | |
| | Unit 715 measures current | |
| | in real time | |
| 5*Presses ‘Record’ button | Unit 715 stores current | Unit 715 chimes |
| 758 | reading in buffer | Illuminates ‘Action’ LED |
| | Unit 715 displays captured | 764 |
| | reading | LCD 742: buffered value |
| | | LCD 742: ‘reading ok?’ |
| | | LCD 742: ‘Yes/Next to |
| | | save, |
| | | LCD 742 ‘No/Skip to |
| | | discard’ |
| Presses ‘No/Skip’ 754 or | Unit 715 clears current | LCD 742: ‘reading |
| lets 20 seconds elapse | reading from buffer | discarded’ |
| | | LCD 742: ‘Yes/Next to |
| | | retake’ |
| Met criteria in step above | Unit 715 reverts back to | LCD 742: ‘data that was on |
| and then Presses | previous display for point | screen prior to pressing |
| ‘Yes/Next’ button 756 | reading | ‘No/Skip’ or letting 20 |
| | | seconds elapse |
| When presented decision in | Unit 715 shifts current | LCD 742: ‘reading stored’ |
| step 5* above, pressed | reading from buffer to | Unit 715 chimes |
| ‘Yes/Next’ 756 within 20 sec | RAM (temp memory used | Illuminates ‘Action’ LED |
| Presses ‘Record’ button | during operation) | 764 |
| 758 | | LCD 742: ‘Next point’ |
| | | LCD 742: ‘next point to be |
| | | read’ |
| Starts over at step 3* above | Unit 715 stores 24 readings | LCD 742: ‘readings stored’ |
| and repeats until all 24 | in RAM | LCD 742: ‘Yes/Next to |
| diagnosis points are | Unit 715 computes and | plot’ |
| committed to RAM | stores average reading of | LCD 742: ‘No/Skip to |
| | the 24 readings | skip’ |
| | Unit 715 computes and | |
| | stores range high and range | |
| | low values (average | |
| | reading +/− 20) | |
| Presses ‘No/skip’ 754 | Skip to step 6* below | |
| When presented decision of | 4*Unit 715 presents first 4 | LCD 742: ‘Lu9L:’ value |
| plot or skip, presses | stored readings to LCD 742 | LCD 742: ‘Lu9R:’ value |
| ‘Yes/Next’ 756 | | LCD 742: ‘Pc7R:’ value |
| | | LCD 742: ‘Pc7L:’ value |
| Presses ‘Yes/Next’ button | Unit 715 cycles thru next | LCD 742: next 20 values |
| 756 | 20 points stored in its | |
| | RAM | |
| | this will take 5 more | |
| | screens, total of 6 screens | |
| | for 24 points at 4 lines per | |
| | screen | |
| Presses ‘Yes/Next’ button | 6* presents computed data | LCD 742: ‘average:’ |
| 756 | | average reading |
| | | LCD 742: ‘hi end:’ range |
| | | high |
| | | LCD 742 ‘low end:’ range |
| | | low |
| | | LCD 742 ‘Yes/Next to |
| | | replot’ |
| Presses ‘Yes/Next’ 756 | Back to step 4*above | |
| 1* Presses ‘No/Skip’ 754 | This is the end of Diagnosis | LED i766 illuminates |
| Advanced treatment’ mode | mode, beginning of | If average reading = |
| is normal treatment mode | Treatment mode | zero/default (i.e. user went |
| w/out recommended points | All diagnosis data is lost | straight into treatment), |
| | (unless download from Unit | then LCD 742: ‘Advanced |
| | 715 to remote PC 200) | treatment’ |
| | Unit 715 removes 12 V from | Else if all points fell within |
| | probes 725, 735, sets at no | hi/low range, then LCD |
| | voltage | 742: ‘No treatment |
| | Unit 715 identifies which | required’ |
| | diagnosis points were | Else, LCD 742: ‘treat:’ first |
| | above/below range | treatment point |
| | Unit 715 identifies | |
| | treatment points (pick from | |
| | 48 points, 1:1 assignment of | |
| | the 24 for above/below) | |
| | If at least one reading was | |
| | above/below range hi/low | |
| | and average reading > 0, | |
| | Unit 715 presents first | |
| | recommended treatment | |
| | point to LCD 742 | |
| Presses ‘Show Pic’ 759 | Unit 715 replaces | LCD 742: illustration of |
| button during treatment | characters on screen with | recommended point |
| mode while the Unit 715 is | illustration | |
| displaying the name of a | | |
| recommended point to be | | |
| treated (i.e Lu9R) | | |
| 5 seconds elapse after | Unit 715 replaces | LCD 742: data that was on |
| ‘Show Pic’ 759 pressed per | illustration with data from | screen prior to pressing |
| conditions above | prior screen | ‘Show Pic’ button 759 5 |
| | | seconds ago |
| Presses button 734 | Unit 715 cycles from | LED's 772, 774, 776 |
| (Normal/Half/Min) | Normal (24 V), Half (12 V), | (normal, half, min) toggle |
| | and Min (5 V) as treatment | when button 734 pressed. |
| | voltages | One of these 3 LED's |
| | Note - treatment voltage | illuminated in Treatment |
| | not applied to probes | mode. |
| | 725/735 until ‘Stim/Sedate’ | |
| | button 752 pressed | |
| 2* Places search probe 725 | Treatment voltage is placed | LCD 742: real-time |
| on patient | across probes 725/735 | current value |
| Presses ‘Stim/Sedate’ | Current flows from grip | LCD 742 begins counter, |
| button 752 | probe 735 thru patient to | incremented 1 count per |
| | search probe 725 | second |
| | Unit 715 measures current | Unit 715 chimes once |
| | (conductance) in real time | Illuminates ‘Action’ LED |
| | | 764 for entire duration |
| | | button 752 pressed |
| 7*Releases ‘Stim/Sedate’ | Logic opens circuit | LCD 742 counter freezes |
| button 752 | 700/removes voltage from | LCD 742: ‘Treatment |
| | across probes 725/735 | halted’ |
| | | LCD 742: ‘Stim/Sedate to |
| | | continue’ |
| | | LCD 742: ‘Yes/Next for |
| | | next point’ |
| Presses ‘Stim/Sedate’ | Logic closes circuit places | LCD 742 counter re-starts |
| button 752 | treatment voltage across | |
| | probes 725/735 | |
| Presses ‘Yes/Next’ button | Logic places treatment | If average reading = |
| 756 in response to step 7* | voltage across probes | zero/default, then LCD |
| above. | 725/735 | 742: ‘Advanced treatment’ |
| | | Else if no more |
| | | recommended treatment |
| | | points exist, then LCD 742: |
| | | ‘treatment complete’ |
| | | Else, LCD 742: ‘treat:’ |
| | | next treatment point |
| Go to 2* above | | |

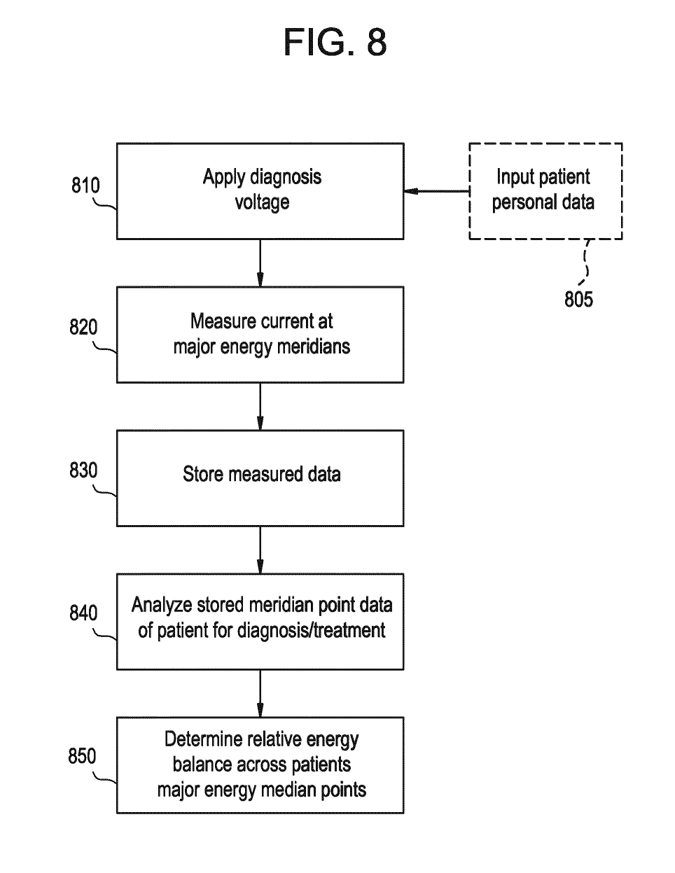

FIG. 8 is a flow diagram for describing a method of managing meridian energy data of a patient to treat the patient, in accordance with an example embodiment of the present invention. Occasional reference may be made to FIGS. 1, 6A and 7A for the following description.

In general, an example methodology 800 of managing meridian energy data of a patient to treat the patient may include applying (810) a diagnosis voltage to the patient at each of the patient's major energy meridian points. As previously described, power source 602 or 702 may generate a Vbatt which is regulated to an output voltage of 12V applied via grip probe 135/735 into the patient's body. This generates a current through the patient ('diagnosis current'). Data corresponding to the patient's major energy meridian points may be measured (820) based on the applied diagnosis voltage, and stored (830) for analysis. In an example, the diagnosis voltage may be generated by processing circuitry in main electronics circuit 600 of the hand-held electronic device 100. For example, a 12 volt voltage may be applied via regulator 614, high speed analog switch 622 (shut based on the logic signal dotted line from the switch 132) and current limiter 623 to generate a voltage (e.g., vdiag=12V) through the grip probe 135 and into the patient, to generate a diagnosis current that is measurable (isense) at search probe 125 to the patient at each of the patient's major energy meridian points. The electronic device 100 is powered by a power source 602 having disposable or rechargeable battery cells and configured to generate a given output voltage under control of the processing circuitry that generates a given current in the patient.

As discussed, a meridian conductivity value may be determined and stored for each of the patient's major energy meridian points for subsequent analysis and/or display. In an example, manual graphing per the Ryodoraku protocol may be used to determine a prescribed treatment. In another example, a software algorithm may be iterated to automatically prescribe the points to be stimulated or sedated for treatment.

This measured energy meridian point data, as discussed above, is a voltage signal representation of the current from the patient, which is converted into a digital signal representation of the current for storage and/or display, as reflected by a displayed conductance value on a suitable display 142/220, for example. This measured data is communicated to the remote computing device 200 for diagnosis or treatment of the patient. As previously discussed, once a point is reached for recording (see FIG. 6C for example), the user depresses actuation button 155 to temporarily record the data in flash memory. The Vsignal corresponding to the recorded data is converted at ADC 636 into a digital signal displayed at LCD 142 and converted into a suitable format at PIC 640 for transmission as an RF signal (after appropriate modulation and coding at transmitter/transceiver 642) via the antenna 140 to the remote computing device 200 over air link 150 (or alternatively via a wired interface such as a USB cable, if such is connected between electronic device 100 and remote computing device 200).

The measured energy meridian point data of the patient may then be analyzed (840) by the caregiver. In an example, the analysis may be performed at a display 220 of the remote computing device. Also recall that the rechargeable cells of the power source 602 are rechargeable by way of the recharging stand or cradle of the battery charger, which is configured to upload data stored in the electronic device 100 via the recharging stand or cradle to the remote computing device 200. In one example, the conductance values may be plotted in each of twelve (12) interior columns by the caregiver using the graph 500 of FIG. 5A to determine the STIM and SED points for treating the patient using the electronic acupuncture device 100. The plot may then be evaluated for determining (850) a relative energy balance across the patient's major energy meridian points. In an example, the recorded conductance data may be displayed (on display 142/220) to facilitate comparison to the graph 500 based on the Ryodoraku protocol.

In another example, a software algorithm executed by the processor 210 of the remote computing device 200 or by the microcontroller in microchip 760 may compare each of the conductance values against the Ryodoraku chart to determine relative energy balance data, e.g., what current (STIM/SED) to apply to each meridian energy point on the patient's body so as to achieve balanced body energy across all meridian points.

Based on the calculated relative energy balance data, a treatment voltage is applied by the processing circuitry of the electronic device 100 to the patient. (generating a ‘treatment’ current in the patient) at each of the patient's major energy meridian points to move energy from over-excited meridian points to under-excited meridian points, or vice versa, so as to achieve the desired relative energy balance across the patient's major energy meridian points. As discussed previously, the Vbatt from power source 602/702 may be regulated to output a voltage greater than 12V to be applied to the patient's body, such as in a range of 12 to 24 volts. Additionally, if a patient is overly sensitive to a current generated at 12V or greater, a lower treatment voltage of 5-6 volts may be applied.

Optionally, the methodology may 800 include inputting patient data (805). For example, the patient's pertinent personal data (height, weight, blood type, date of birth, etc.), may be entered, such as through a suitable query window or screen, and cross-checked against a database in remote computing device 200, stored in ROM within main unit 715, or stored in another accessible external memory. This stored patient data may be used by a caregiver for historical trend analysis, to help the caregiver recognize medical conditions that become apparent over time. The caregiver can thus track a patient's progress over repeated treatments, and may permit the gathering and analysis of mass data from multiple patients and caregivers, such as through Internet downloads, to evaluate and improve the efficacy diagnosis or treatment, for example.

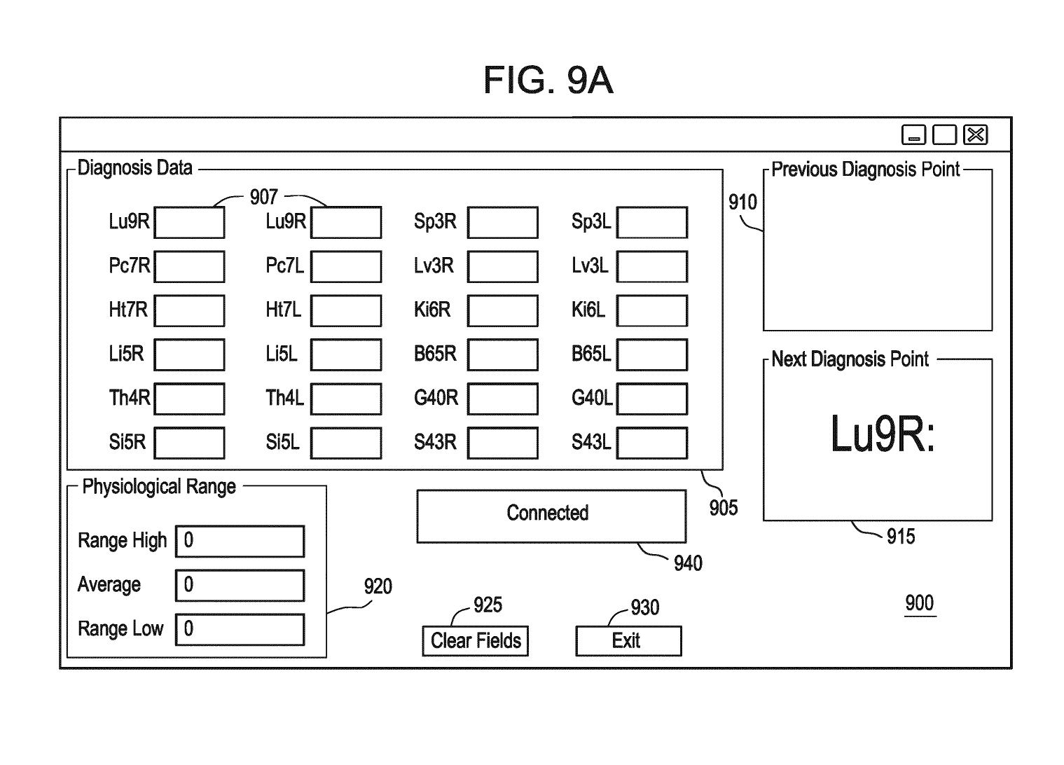

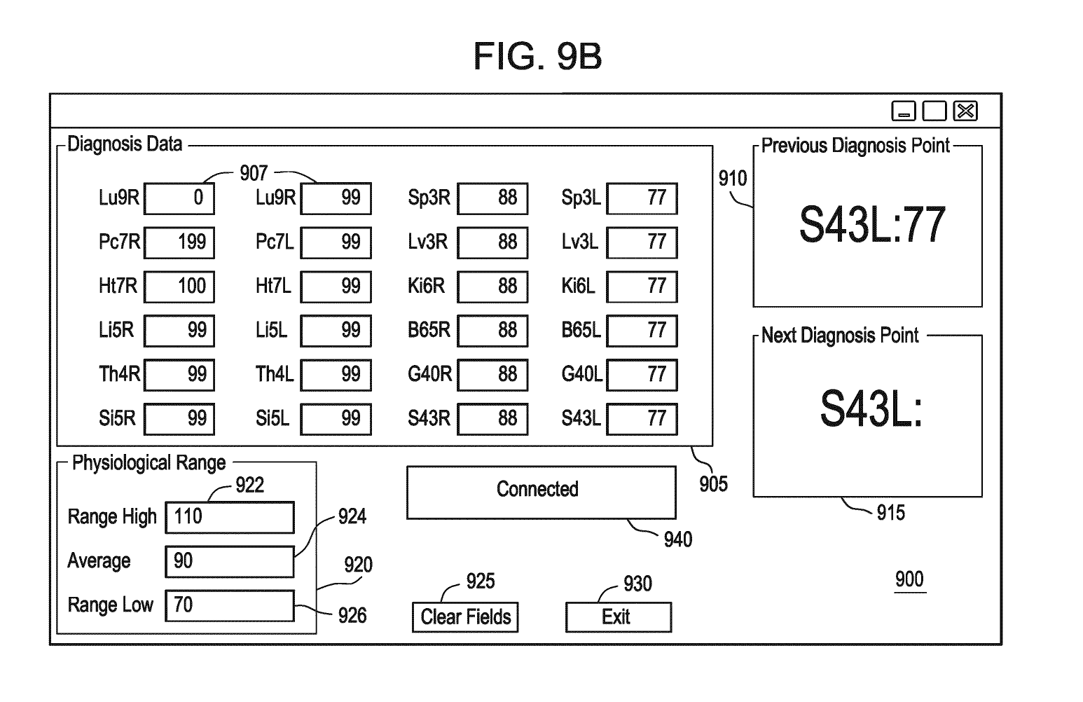

FIGS. 9A and 9B are screen shots illustrating exemplary data displayed to a user of the system 1000 in accordance with an example embodiment of the present invention. Referring to FIG. 9A, example display screen 900 illustrates the recorded data that may be used to analyze a patient for diagnosis and/or treatment. Display screen 900 may be associated with remote computing device 200, for example. Display screen 900 may include a diagnosis data window 905 which includes data cells 907 for displaying each of the 24 points measured, so as to properly diagnose the patient by running and measuring the 12V diagnosis current through 24 points around the wrist and/or feet of the patient. The 24 points may be evaluated utilizing the Ryodoraku protocol, either by hand or via software implementation.

To assist the caregiver, display screen includes a previous diagnosis point window 910 and a next diagnosis point window 915. These windows shift once the caregiver/patient has pressed the record button 150/758 on the main unit of the electronic acupuncture device. Screen 900 includes a selectable clear field's window 925 and an exit window 930. Screen 900 may optionally include an indicator 940 to inform the caregiver whether communications in system 1000 between the electronic device 100 and remote computing device 200 are connected or disconnected.

FIG. 9B illustrates the display after a complete set of conductance values have been recorded for a patient, as shown in cells 907. As shown in FIG. 9B, screen 900 may further include a psychological range window 920. The Psychological range Window 920 is provided for determining which meridians, if any, are above range (over-excited and in need of sedation) or below range (under-excited and in need of stimulation) and includes a range high cell 922, an average cell 924 and a range low cell 926. The 24 diagnosis readings with physiological ranges may be displayed in graphical format, such as by a colored bar chart, using differing colored bars to show over-excited readings, readings within the physiological range and under-excited readings, for example.

Although described primarily in terms of hardware above, the example methodology implemented by one or more components of the example system described above may also be embodied in software as a computer program. For example, a program in accordance with example embodiments of the present invention may be a computer program product causing a computer or a microprocessor to execute a method of managing meridian energy data of a patient by implementing the functionality as described FIG. 8, for example.

The computer program product may include a computer-readable medium having computer program logic or code portions embodied thereon for enabling a processor of the system in accordance with an example embodiment to perform one or more functions in accordance with the example methodology described above. For example, the computer program logic may cause a processor in one of the remote computing device 200 (processor 210) or main unit assembly 115/715 of device 100 (e.g., chip 760) to direct the application of the diagnosis voltage to the patient at each of the 12 energy meridian points, and to measure the conductance values based on the current read from the patient through search probe 125/725. The computer program logic may cause the processor to iterate software-based functionality to analyze the measured energy meridian point data and display the data for comparison to a graph based on the Ryodoraku protocol, or to iterate software-based functionality which is configured to compare the data to the Ryodoraku protocol and to determine or calculate a relative energy balance across the patient's major energy meridian points based on the comparison.

The computer-readable storage medium may be a built-in medium installed inside a computer main body such as the remote computing device or a removable medium arranged so that it can be separated from the computer main body and/or so it may be configurable in the main unit of the electronic acupuncture device. Examples of a built-in medium include, but are not limited to, rewriteable non-volatile memories, for example, RAM, ROM, flash memories and hard disks. Examples of a removable medium may include, but are not limited to, optical storage media, for example, CD-ROMs and DVDs; magneto-optical storage media, for example, MOs; magnetism storage media, for example, floppy disks (trademark), cassette tapes, and removable hard disks; media with a built-in rewriteable non-volatile memory, for example, memory cards; and media with a built-in ROM, for example, ROM cassettes.

These programs may also be provided in the form of an externally supplied propagated signal and/or a computer data signal embodied in a carrier wave (e.g., transmission through the internet). The computer data signal embodying one or more instructions or functions of the example methodology as described in FIG. 8 may be carried on a carrier wave for transmission and/or reception by an entity (such as the electronic acupuncture device 100 or remote computing device 200) that executes instructions or functions of the example methodology.

For example, the functions or instructions of the example method may be implemented by processing one or more code segments of the carrier wave in a computer controlling one or more of the components (main unit 115, remote PC 200, etc.) of the example system as shown in any of FIG. 1, 6A, 6B, 7A or 7B-1/2 where instructions or functions may be executed for implementing one or more functions for managing meridian energy data of a patient. Code segments of the carrier wave in an example may carry instructions to direct the application of the diagnosis current to the patient at each of the 12 energy meridian points and to measure the conductance values based on the current read from the patient through search probe 125. Code segments of the carrier wave may carry instructions to cause a processor to iterate software-based functionality to analyze the measured energy meridian point data and to display the data for comparison to a graph based on the Ryodoraku protocol. In another example, code segments of the carrier wave may carry instructions to a processor for iterating functionality software-based functionality configured to compare the data to the Ryodoraku protocol and to determine or calculate a relative energy balance across the patient's major energy meridian points based on the comparison. Code segments of the carrier wave may further carry instructions to direct the application of the treatment current to the patient to achieve the relative energy balance across the patient's major energy meridian points.

Further, such programs, when recorded on computer-readable storage media, may be readily stored and distributed. The storage medium, as it is read by a computer, may enable the managing of a patient's meridian energy data in accordance with the example methods described herein.

### Pressure Control for Search Probe

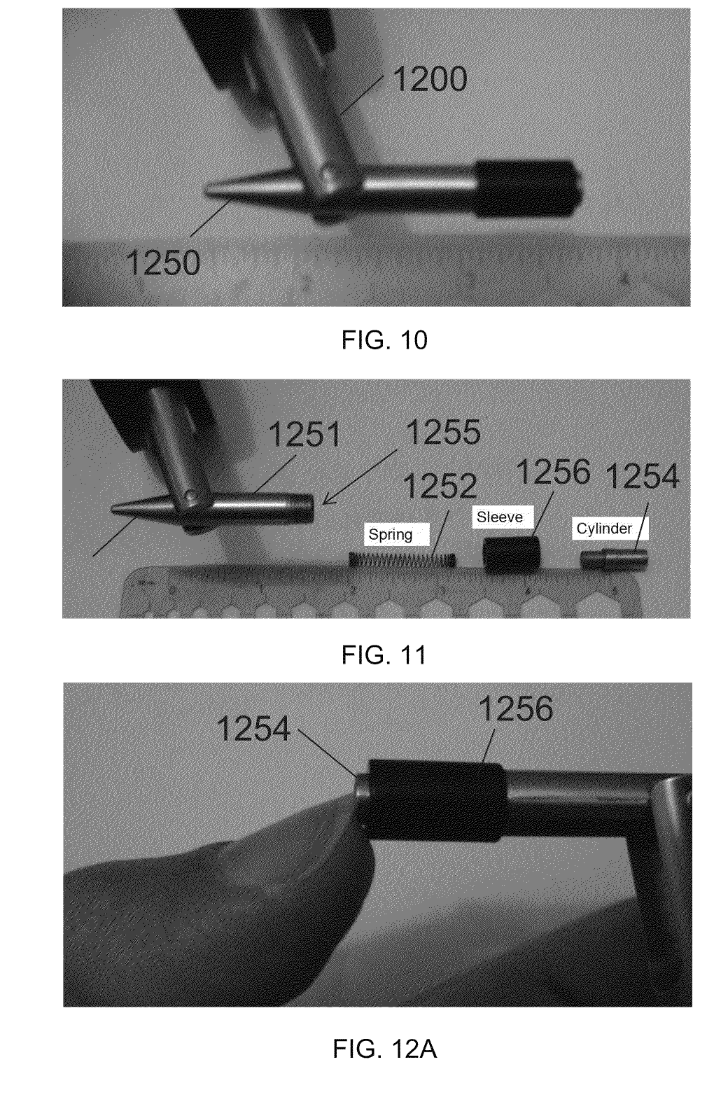

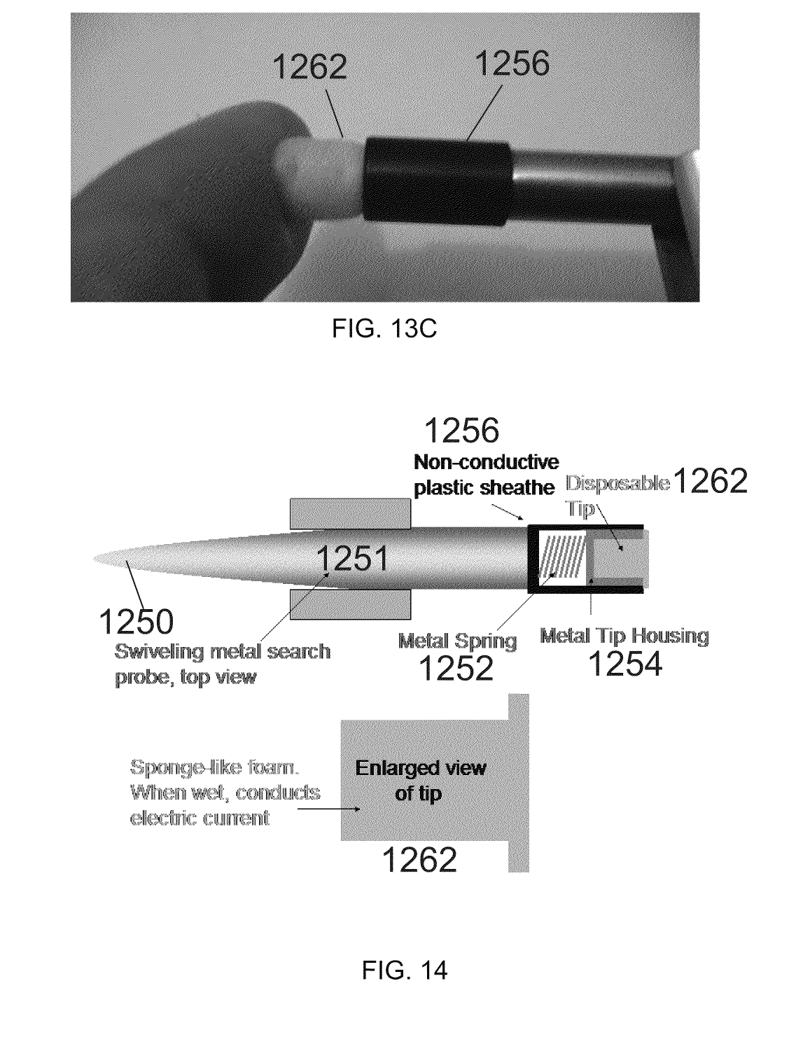

Pressure control of search probe 125 has been described briefly with regard to FIG. 3. FIGS. 10-12B describe another pressure control configuration with regard to another example search probe 1250. FIGS. 13A to 16 illustrate further embodiments of the search probe with moisture control of the tip of the search probe and other pressure control implementations.

FIG. 10 is an enlarged top view of a search probe 1250 in accordance with an example embodiment. The search probe 1250 is somewhat similar to probe 125 in FIG. 1, in that it is used for evaluation and treatment, and is held by an extension 1200 (only a portion shown) which extends from the main unit assembly 115 as shown in FIG. 1; the extension 1200 houses search probe 1250.

As previously described above, in the administration of electronic acupuncture and/or electronic meridian therapy, there is a diagnosis/evaluation function during which electronic micro-current is applied and measured (in microamperes) for quantitative analysis. A factor in controlling the accuracy of the evaluation function is maintaining constant pressure on the skin when applying the micro-current.

Instead of requiring the user to judge pressure manually (i.e., by using their best guess of tactile feedback, which introduces subjectivity and error into the analysis), the search probe 1250 employs a mechanical solution to ensure constant pressure during evaluation (diagnosis) and stimulation (treatment) to regulate accuracy.

FIG. 11 illustrates an exploded view of the search probe 1250 to show its constituent components. As generally discussed above, the search probe 1250 is constructed of metal or any other electrically conductive material, or can contain a conductor within it to permit the administration of the evaluative (diagnosis) current. As shown in FIG. 11, the search probe 1250 includes a body 1251 which receives a spring 1252 and a cylinder 1254; a portion of the body 1251 is wrapped by a sleeve 1256. The cylinder 1254 contacts the spring 1252 within a hollow interior section 1255 of the probe body 1251. As will be described hereafter, the spring 1252, cylinder 1252 and sleeve 1256 in concert provide pressure control, i.e., the pressure at which a tip of the search probe 1250 contacts the skin of the patient. This tip of probe 1250 may be just the cylinder 1254 as shown in FIG. 11, or a cylinder 1254 that includes a moistened or moisture-controlled tip thereon)

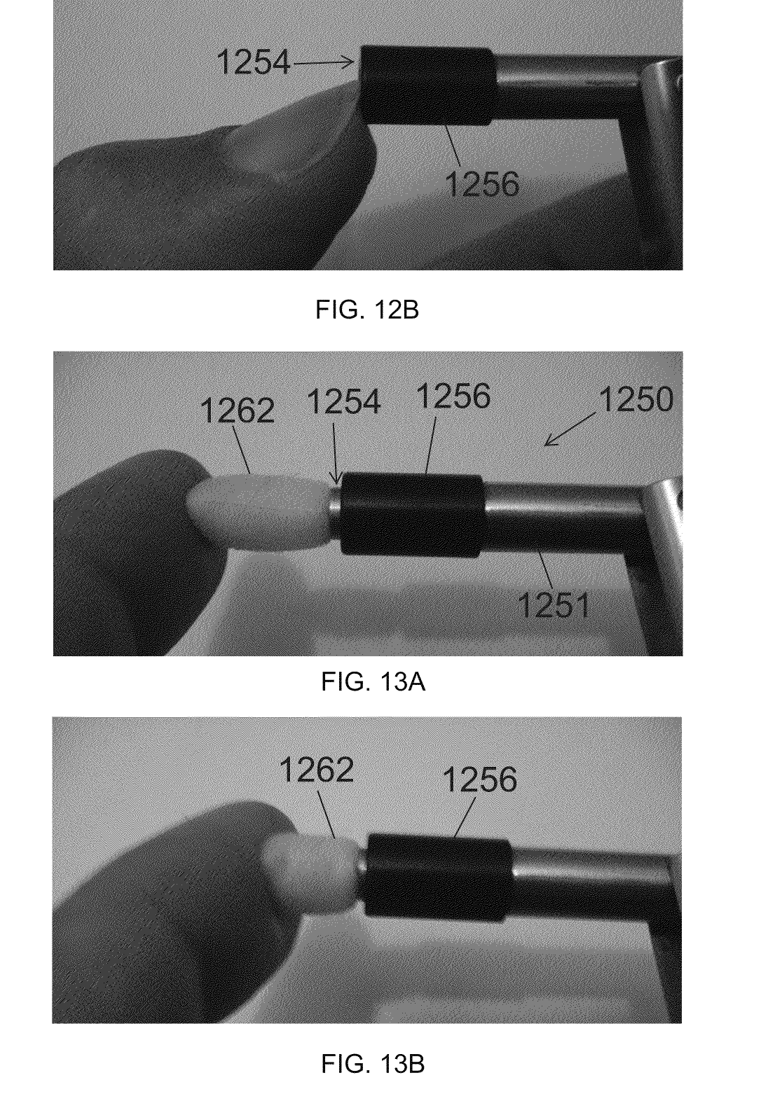

FIGS. 12A and 12B illustrate user operation of the search probe 1250. The probe 1250 is shown without any moistened or moisture controlled tip thereon to illustrate probe movement due to backpressure; the cylinder 1254 is the tip. It should be understood that the electronic acupuncture device 100 can include a tip with or without a moistening mechanism. As shown in FIG. 12A, as the probe 1250 is pressed against the patient's skin (with or without a moisture controlling tip) backpressure from the skin pushes the cylinder 1254 and compresses the spring 1252 within (not shown). The spring 1252 is conductive, and electric current flows through it but not through the sleeve 1256.

As shown in FIG. 12B, once the cylinder 1254 is pushed completely into the hollow section 1255 of the probe body 1251 such that it is flush with the sleeve 1256, the sleeve 1256 absorbs any additional pressure in the event that the user presses too hard against the skin. The sleeve 1256's absorption of additional pressure maintains a constant pressure on the skin as felt by the cylinder 1254 and maintained by the spring 1252, the length and compression of which is held constant when the cylinder is pushed into the hollow section 1255 within sleeve 1256.

Accordingly, the combination of the spring 1252, cylinder 1254 and sleeve 1256 provide the user with pressure control that helps to prevent an erroneous reading, as in a case where the user is pressing the search probe too hard against the patient's skin.

FIGS. 13A to 13C illustrate user operation of the search probe 1250. FIG. 2 generally described a search probe 125 with a self-moistening tip 262 (moistened from a reservoir) to ensure proper electrical conduction of the patient's internal body current into the electronic device 100. FIGS. 13A-13C illustrates another kind of moistened tip 1262. If a moisture control tip 1262 such as is shown in FIGS. 13A-C is used, it may be chosen of a small enough size to fit within the cylinder 1254 so that it recedes into the cylinder 1254 and/or is contained within the sleeve 1256. This is so that its conductivity is unaffected by pressure absorbed by the sleeve. Additionally, as shown in FIGS. 13A-13C, the tip 1262 can be shaped and sized so that the back end of the tip touches the plastic sleeve 1256 at the moment where the desired pressure is applied.

FIGS. 14 through 16 illustrate other embodiments for providing pressure control with a moistened tip. In FIG. 14, a moisture control tip 1262 may be sized and shaped to more closely conform to the pressure control probe 1250. In this figure, the tip 1262 has a diameter which is less than the diameter of sleeve 1256 so as to fit' within sleeve 1256 and to compress spring 1252. Further, the tip 1262 can be embodied as a metal housing which is shown as having several possible shapes. The tip 1262 end can be flat, rounded, beveled or chamfered, or configured in another shape to control the surface area/pressure on the skin and/or to prevent skin from pinching.

As shown in FIGS. 15 and 16, pressure control may also be achieved with solid or hollow shapes made of metal or other conductive material, in which the tip section can be detachable or removable to allow different diameters, pressures, and/or spring characteristics. Each of FIGS. 15 and 16 illustrate a recessed interior threaded member within body 1251 that is adapted to receive a removable section 1275 comprising probe tip end that includes the sleeve 1256, interior spring 1252 and tip 1262 within sleeve 1256.

In alternate embodiments, the removable sections 1275 can be configured so as to snap fit within body 1251, and/or be arranged in another, non-permanent but sturdy configuration. The pressure control designs of FIGS. 15 and 16 may further be implemented with the self-moistening tip 1262 as described in FIG. 2, in which the tip 262 is part of a hammerhead 261 which also includes a reservoir 265 and permeable membrane. As discussed previously, the moisture in tip 1262 helps to ensure proper electrical conduction of the patient's internal body current into the electronic device 100.

### Moisture Control in Search Probe Tip

In the administration of electronic acupuncture and/or electronic meridian therapy, there is a diagnosis/evaluation function during which electronic micro-current is applied and measured (in microamperes) for quantitative analysis. Another factor in controlling the accuracy of the evaluation function is maintaining constant moisture on the skin when applying the micro-current device.

Present devices either ignore moisture control or require the user to tear bulk cotton or cut cotton swabs, which introduces the pooling of liquid, the constant re-wetting of swabs, and subjectivity and error.

FIG. 17 is a standalone view of a moisture-controlled tip. In an example, a tip 2260 can be configured as a composite cotton and foam article to facilitate constant moisture during evaluation (diagnosis) and stimulation (treatment) to regulate accuracy. The tip 2260 of FIG. 17 includes a stem 2261 that may be made of wood, polypropylene, or other rigid material that provides structural integrity. The tip 2260 includes an absorbent core 2263 made of cotton or some other absorbent material that is attached to the stem 2261. An outer “sack” or an outer membrane 2265 made of foam or some other absorbent and permeable material is wrapped around the core 2263 of the tip 2260.

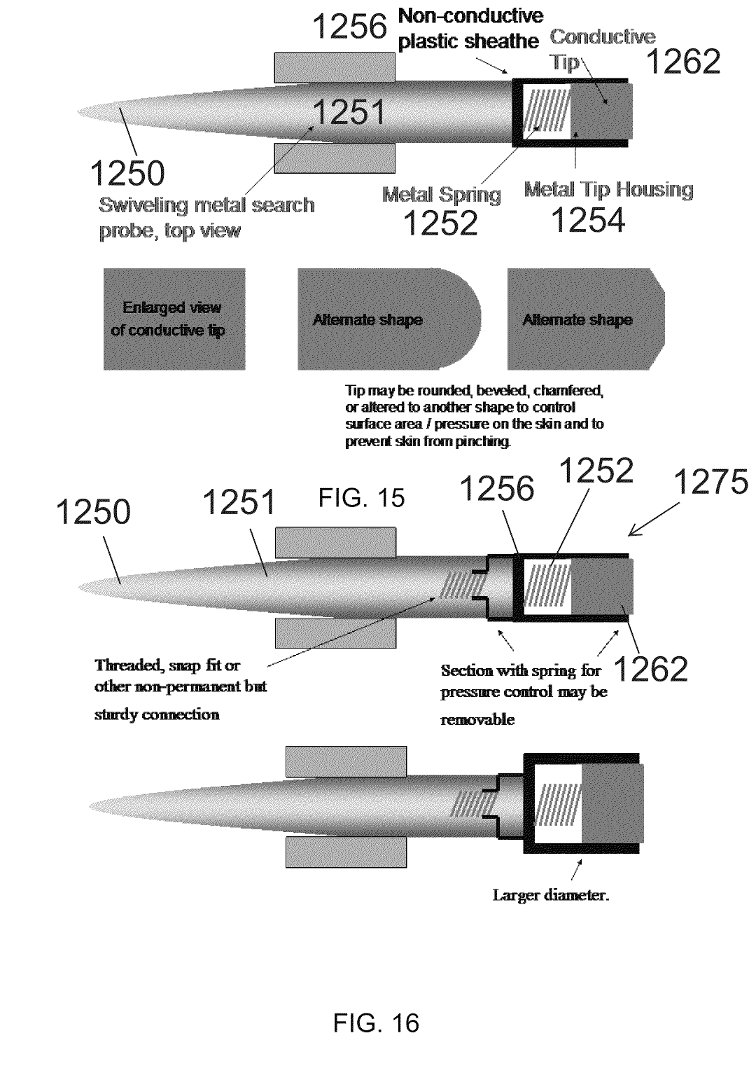

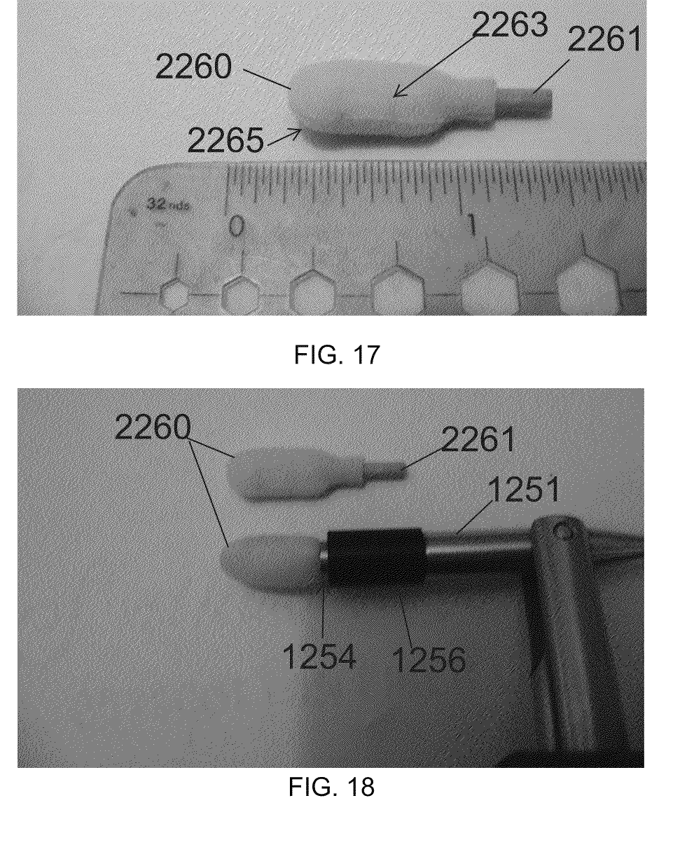

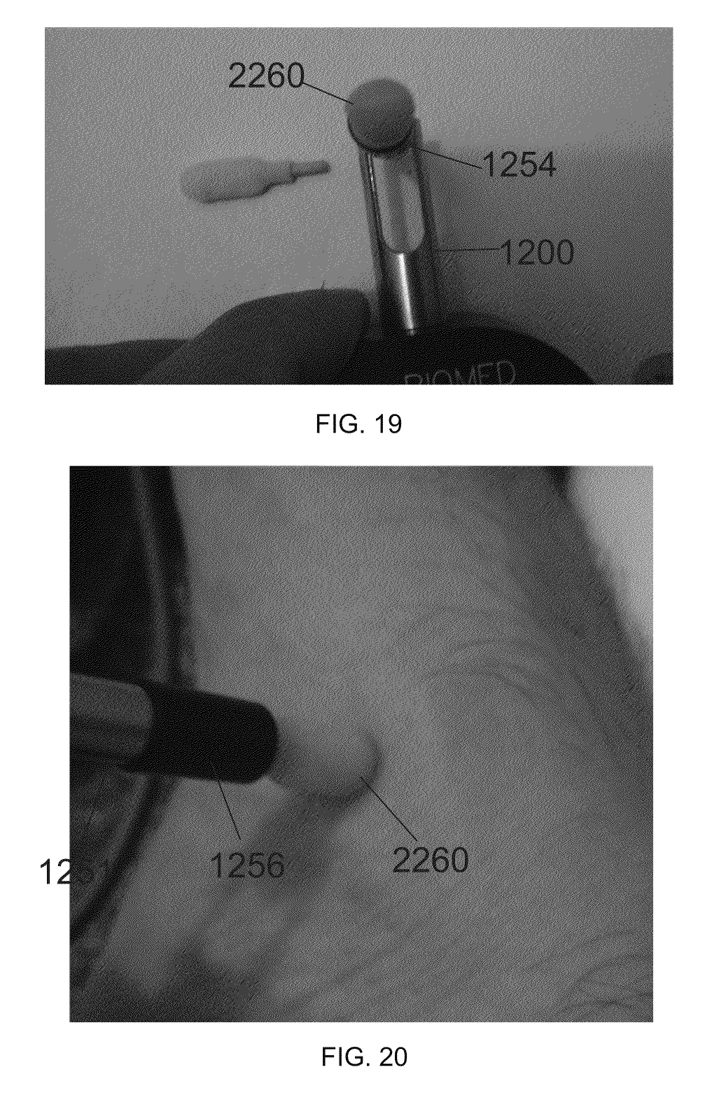

FIGS. 18 and 19 are perspective and top views to show the tip 2260 attached to the search probe 1250. The stem 2261 can be of a diameter and cut to length to fit within the conductive cylinder 1254 of the search probe 1250, which is used to apply electric current to a patient's skin in the application of electronic therapies such as electronic acupuncture, nerve stimulation, or muscle stimulation. In one demonstrative example, the cylinder 1254 is assumed to be the pressure probe of some application x. For simplicity, the tip 2260 is designed to fit snuggly within the cylinder 1254 to allow inversion of the probe 1250 against gravity, so that the tip 2260 remains stationary with respect to the cylinder 1254, but allows the user to manually remove the tip 2260 after use. However, in an alternative, any locking mechanism, such as threads, détentes, twist-locking, snap-fit, etc. could be used.

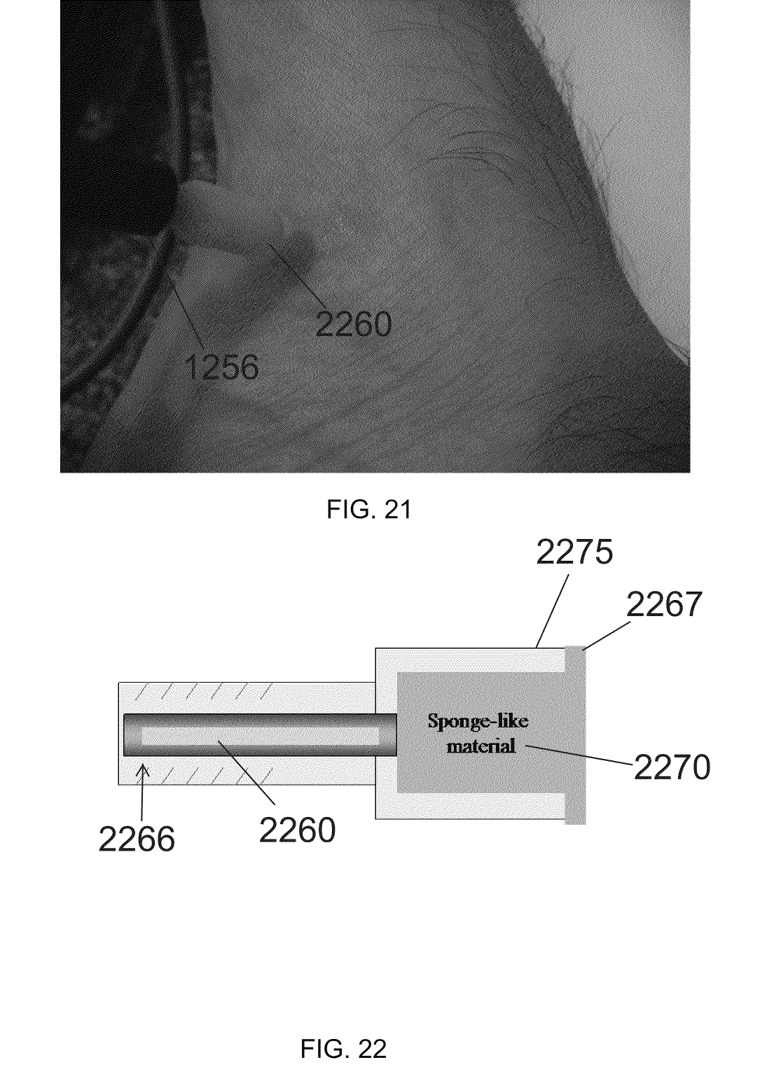

FIGS. 20 and 21 are photographs provided to illustrate the moisture applied by tip 2260 on a patient's skin. The tip 2260 may be stored and delivered in water or other fluid, or it may be stored and delivered dry for the user to saturate before use. By immersing the tip 2260 in a conductive fluid such as ionized water, the fluid seeps through the outer permeable membrane 2265 such as foam) and saturates the inner core 2263. The immersion and saturation permits storage of fluid in the tip 2260, predominantly in the core 2263, thus allowing the user to have adequate moisture for administration of therapy without having to stop and rewet the device.

When a moistened tip 2260 is applied to the skin (as shown in FIG. 20), pressure from the skin draws fluid from the tip 2260. The example design of tip 2260 allows for adequate fluid to wet an area approximately equal to that of an acupuncture point (roughly 1 cm diameter). Unlike using cotton alone, the example tip 2260 design reabsorbs excess fluid as it is lifted from the skin and as it is allowed to re-expand to its normal size and shape. This prevents unwanted pooling and mess while ensuring that a constant amount of fluid is applied over a constant diameter of skin during therapy. The application of the tip 2260 to skin with a desired amount of glistening water left on the skin is illustrated in FIGS. 20 and 21.

In another variation, the tip 2260 inclusive or core 2263 and foam membrane or wrap 2265 can be contained in a casement, such as a metal casing that includes pin holes or a permeable membrane at an end thereof that contacts the patient's skin, to allow fluid top enable moisture from core 2263 to flow permeable. Moreover, this metal casing can be similar to the removable section 1275 in FIGS. 15 and 16 that includes a probe tip 2260 therein and which has an end having pin holes or a permeable membrane. The section 1275 may or may not also include the sleeve 1256, interior spring 1252 and metal tip 1262 within sleeve 1256. In alternate embodiments, the removable sections 1275 can be configured so as to snap fit within body 1251, and/or be arranged in another, non-permanent but sturdy configuration.

FIGS. 22-24 illustrate other variations for moisture control in the probe tip 2262. For example, FIG. 22 illustrates the probe tip 2260 within an interior cavity 2266 of an outer metal casing 2275, such as the removable section 1275 of the probe 1250 shown in FIGS. 15 and 16. The probe tip 2260 in this example is made of a sponge-like material 2270 and includes a contiguous lip 2267 that extends outside the cavity and across the diameter of casing 2275 for contact against the patients skin. The sponge material of probe tip 2260 is designed to hold sufficient fluid for a given diagnosis/treatment session of the patient, then removed from cavity 2266 and is replaced with a fresh tip 2262 for a next patient.

FIG. 23 is a variant of FIG. 22 and replaces the lip 2267 with a strip 2268 that serves as a tip. Strip 2268 can adhesively or mechanically adhere to the casing 2275 so as to contact a moist sponge-like material 2270 within casing. Unlike FIG. 23, after a session with a patient, only the strip 2268 is removed.

FIG. 24 is a further variant on FIGS. 22 and 23 and is somewhat similar to FIG. 2, in that there is a reservoir and permeable membrane. In FIG. 24, the reservoir 2269 can be filled with some type of conductive solution. Flow rate and hence moisture control, may be possible with the use of a water-permeable membrane 2271 located between a sponge like-outer contact lip 2272 and the reservoir 2269. The lip 2272 may be mechanically or adhesively attached to casing 2275 so that it can be removed and disposed of after a patient session.

### Voltage Control

A factor in achieving accuracy during the diagnosis phase of electronic acupuncture is maintaining a constant voltage, especially a steady direct current (DC) voltage. This has been explained in general above. However, in another embodiment, the user can control the voltage of the device 100, i.e., he or she can select the DC voltage to use in evaluation/diagnosis of a patient's health, and also in the stimulation or treatment.

Reasons to set a voltage lower may be if a patient is hyper-conductive (due to illness, youth, time of day, warm weather season, environmental condition, stress, diet, etc.), the voltage is at a point where readings become meaningless or to a point where the patient experiences discomfort due to excessive current. Reasons to set a voltage higher may be if a patient is hypo-conductive (due to similar but opposing reasons above) and readings are too low to be meaningful.

Voltage may be set on an analog scale between a minimum and maximum voltage of, for example, 3VDC to 12VDC. Voltage levels may also be set digitally by push button, selector switch, or other digital control to a range between or a selection of discrete voltages, such as 12VDC, 6VDC, 3VDC.

A user may determine such as through independent analysis or through trial and error in administering diagnosis for example, that the diagnosis voltage should be changed. The diagnosis protocol may also include a representative point or representative points, independent of those to be measured in diagnosis, to measure the patient's general overall electrical conductivity as an indication to set the proper diagnosis voltage. Selecting the representative points may enable users to set the proper diagnosis voltage without the risk of skewing the diagnosis accuracy caused by over-stimulating the points that are to be measured in diagnosis.

User voltage control can also be applied in the stimulation or treatment phase of electronic acupuncture, most specifically when adjusting voltage to optimize the stimulation within the patient's comfort and tolerance to electrical conductivity. Voltages may be higher for treatment than for diagnosis, up to 24VDC or higher, for example.

### Treatment/Stimulation Algorithm

### APPENDIX A

One paradigm of acupuncture therapy is determining how to redistribute and rebalance the energy among the body's twelve major meridians. Many approaches to this involve applying the Chinese Five Elements theory that, among other uses, governs the management of energy between the twelve major meridians.

In the administration of electronic acupuncture that measures the relative health and energy levels of the twelve major meridians, including a left versus right side of the body distinction, as few as 24 measurements can be made. In such an approach, exemplified by the Ryodoraku protocol, the Five Elements theory may be applied in determining how to redistribute and rebalance the body's energy to promote health and treat disease under the paradigm of acupuncture.

In the case of the Ryodoraku protocol, 24 measurements are made. Once made, if each measurement is simplified as being in one of three states relative to the other 23 measurements—above average (stimulated), average (in range), or below average (deficient) —then there are 3²⁴ or greater than 28 billion combinations of measurements, which is impossible using present software techniques to embed in a software program in order to recommend treatment.

The example methodology described in Appendix A reflects an algorithm designed to reduce this complexity and to recommend a prescribed approach to redistributing and balancing the body's energy to promote health and treat disease under the paradigm of acupuncture. The algorithm is described in detail in Appendix A is attached hereto after FIG. 24.

In summary, Appendix A details the following functional steps for managing meridian energy data of a patient to treat the patient: (i) a check of bilateral (left, right side of body) imbalances; (ii) intra-fire checks (imbalances between heart/pericardium, small intestine/triple heater); (iii) remaining imbalance program checks; (iv) 5-elements treatment (evaluating YYO (yin-yang opposite) and most excess TOP point, and YYO-1 to YYO-4, TOP-1 to YOP-4); (v) error catch. As Appendix A explains these functions steps in explicit detail, an explanation herein is omitted for purposes of brevity.

The example embodiments being thus described, it will be obvious that the same may be varied in many ways. Such variations are not to be regarded as departure from the spirit and scope of the example embodiments, and all such modifications as would be obvious to one skilled in the art are intended to be included within the scope of the following claims.

What is claimed:

1. A method of managing meridian energy data of a patient to treat the patient, comprising:
applying a diagnosis voltage generated by a processor in a hand held electronic device to the patient at each of the patient's major energy meridian points, the electronic device powered by a power source having disposable or rechargeable battery cells and configured to generate a given output voltage under control of the processor that generates a given current in the patient,
measuring data by the electronic device that corresponds to the patient's major energy meridian points based on the applied diagnosis voltage,
communicating the measured data to a remote computing device for diagnosis or treatment of the patient,
analyzing the measured energy meridian point data of the patient at the remote computing device, the rechargeable cells of the power source rechargeable by way of a recharging stand or cradle of a battery charger configured to upload data stored in the electronic device via the recharging stand or cradle to the remote computing device, and
determining a relative energy balance across the patient's major energy meridian points based on the analysis.

2. The method of claim 1, wherein analyzing includes:
displaying the data for comparison to a graph based on the Ryodoraku protocol.
determining a relative energy balance for each of the patient's major energy meridian points at the remote computing device based on the comparison.

3. The method of claim 1, wherein applying the diagnosis voltage further includes generating an output voltage at 12V via the hand-held electronic device to be sent through the patient's body.

4. The method of claim 1, wherein, based on determined relative energy balance data, further comprising:
applying a treatment voltage via the hand-held electronic device to the patient at each of the patient's major energy meridian points to move energy from over-excited meridian points to under-excited meridian points, or vice versa so as to achieve a relative energy balance across the patient's major energy meridian points.

5. The method of claim 4, further comprising applying voltage control to at least one of the diagnosis voltage and the treatment voltage.

6. The method of claim 4, wherein applying the treatment voltage further includes generating an output voltage at greater than 12V from the hand-held electronic device to be sent through the patient's body.

7. The method of claim 6, wherein the output voltage is in a range of about 12 to 24 volts.

8. The method of claim 6, wherein the output voltage is 24 volts.

9. The method of claim 1, wherein measuring further includes recording meridian conductivity values at each of the patient's major energy meridian points for analysis and/or display at the remote computing device.

10. The method of claim 1, further comprising inputting patient data.

11. An electronic acupuncture system for providing noninvasive acupuncture treatment for a patient, comprising:
a hand-held electronic acupuncture device including a pressure sensitive, search probe having a pressure sensitive search probe operatively connected to the main unit, the search probe having a self-moistening probe tip adapted to apply pressure against the skin of a patient and to receive a current from the patient, the probe tip subject to moisture control so as to have consistent moisture and the search probe subject to pressure control so that the probe tip is applied with a constant pressure to a patient's skin, and
a remote computing device, the electronic acupuncture device configured to communicate measurable patient data to the remote computing device for diagnosis or treatment of the patient.

12. The system of claim 11, wherein the search probe includes a cylinder with an open end for insertion of a replaceable probe tip therein.

13. The system of claim 11, wherein the search probe has a cavity opening at an end thereof for fixed insertion of a removable member that includes mechanical means for pressure control and includes the probe tip therein.

14. The system of claim 11, wherein the search probe has a cavity opening at an end thereof which includes a reservoir of fluid feeding a removable strip element attached to the reservoir for contact with a patient, a membrane arranged between the reservoir and strip element.

15. The system of claim 11, wherein the search probe further includes:
an elongate probe body having a hollow section at one end thereof,
a sleeve fitting over a part of the body with the hollow section,
a cylinder for traveling into the hollow section, the cylinder configured to receive the probe tip, and
a spring providing a counter force against the cylinder within the hollow section,
wherein as the cylinder is pushed completely within the hollow section to be flush with the sleeve, the cylinder absorbs any additional pressure to maintain a constant pressure of the probe tip on the skin of the patient, as the cylinder is maintained in place within the sleeve and held constant by the spring.

16. The system of claim 11, wherein the remote computing device is configured to store and analyze multiple meridian energy point data contained in the measurable patient data for holistic analysis, and includes a display to indicate the multiple points of meridian energy data for the holistic analysis by one of a caregiver of the patient or the patient.

17. The system of claim 11, wherein the electronic device includes transceiver circuitry for communicating with the remote computing device over an air interface, or is connected to the remote computing device via a communication cable to transmit data to and receive data from the remote computing device.

18. The system of claim 11, wherein the electronic device includes:
a switch actuatable to shift the device between a diagnosis state and a treatment state, and
a light-emitting diode (LED) indicating the diagnostic and treatment states.

19. The system of claim 11, wherein the electronic device includes a processor configured to apply a variable voltage to the patient and a power source having disposable or rechargeable battery cells, the rechargeable cells rechargeable by way of a recharging stand or cradle of a battery charger providing an AC source of charging current from one of a wall outlet and a computing device, the battery charger configured to upload data stored in the electronic device via the recharging stand or cradle to the remote computing device.

20. The system of claim 11, wherein
the electronic device is configurable to apply one of a given diagnosis voltage and a given, different treatment voltage to the patient, and
the value of voltage used for diagnosis or treatment of the patient is controllable by the user.

21. A handheld electronic acupuncture device, comprising:
a handhold area operatively connected to a main electronics unit, the main unit including a display thereon and intelligence therein for providing one of diagnosis and/or treatment of a patient,
a pressure sensitive search probe operatively connected to the main unit, the search probe having a self-moistening probe tip adapted to apply pressure against the skin of a patient and to receive a current from the patient, the probe tip subject to moisture control so as to have consistent moisture and the search probe subject to pressure control so that the probe tip is applied with a constant pressure to a patient's skin, and
a grip probe operatively connected via an electrical connector to the main unit, wherein a patient grasps the grip probe and the search probe is applied to the patient's skin to complete an electrical circuit.

22. The device of claim 21, wherein the search probe includes a cylinder with an open end for insertion of a replaceable probe tip therein.

23. The device of claim 21, wherein the search probe has a cavity opening at an end thereof for fixed insertion of a removable member that includes mechanical means for pressure control and includes the probe tip therein.

24. The device of claim 21, wherein the search probe has a cavity opening at an end thereof which includes a reservoir of fluid feeding a removable strip element attached to the reservoir for contact with a patient, a membrane arranged between the reservoir and strip element.

25. The device of claim 21, wherein the search probe further includes:
an elongate probe body having a hollow section at one end thereof,
a sleeve fitting over a part of the body with the hollow section,
a cylinder for traveling into the hollow section, the cylinder configured to receive the probe tip, and
a spring providing a counter force against the cylinder within the hollow section,
wherein as the cylinder is pushed completely within the hollow section to be flush with the sleeve, the cylinder absorbs any additional pressure to maintain a constant pressure of the probe tip on the skin of the patient, as the cylinder is maintained in place within the sleeve and held constant by the spring.

26. The device of claim 21, wherein the main unit includes a processor configured to apply a variable voltage to the patient and a power source having disposable or rechargeable battery cells, the rechargeable cells being rechargeable by way of a recharging stand or cradle of a battery charger providing an AC source of charging current from one of a wall outlet and a computing device, the battery charger configured to upload data stored in the electronic device via the recharging stand or cradle to the remote computing device.

27. The device of claim 21, wherein the value of voltage used for diagnosis or treatment of the patient is controllable by the user.
